(19) United States
(12) Patent Application Publication
(10) Pub. No.: US 2019/0058617 A1
(43) Pub. Date: Feb. 21, 2019

(54) Antenna and Cabling Unification

(71) Applicant: Qualcomm Incorporated, San Diego, CA (US)

(72) Inventors: Arild Kolsrud, El Cajon, CA (US); Mark Cherry, Oceanside, CA (US)

(21) Appl. No.: 16/108,045

(22) Filed: Aug. 21, 2018

Related U.S. Application Data
(60) Provisional application No. 62/548,379, filed on Aug. 21, 2017.

(51) Int. Cl. H04L 27/00; H04L 12/40; H04L 27/14; H04B 1/3827

(52) U.S. Cl. CPC H04L 27/0002; H04L 12/40045; H04B 2001/3866; H04B 1/3833; H04B 1/385; H04L 27/14

(57) ABSTRACT

Apparatuses, methods, and electronic devices are disclosed for antenna and cabling unification. In an example aspect, an electronic device includes a cabling connector, a digital interface, and a radio. The cabling connector includes multiple pins configured to couple the electronic device to a device connector of an external cabling apparatus. The multiple pins include a positive digital pin, a negative digital pin, and a first other pin. The digital interface includes a positive interface node and a negative interface node. The positive interface node is coupled to the positive digital pin, and the negative interface node is coupled to the negative digital pin. The radio includes an antenna node coupled to at least the first other pin.

### CROSS-REFERENCE TO RELATED APPLICATION

This application claims the benefit of U.S. Provisional Application No. 62/548,379, filed 21 Aug. 2017, the disclosure of which is hereby incorporated by reference in its entirety herein.

### TECHNICAL FIELD

This disclosure relates generally to wireless signal reception and, more specifically, to enabling radio frequency (RF) wireless signal reception (e.g., for frequency modulation (FM) wireless signals) by unifying an antenna with a cabling apparatus that includes audio wires.

### BACKGROUND

Examples of electronic devices include desktop computers, notebook computers, tablet computers, smartphones, and wearable devices such as a smartwatch, a fitness tracker, or intelligent glasses. People use electronic devices for productivity, communication, and entertainment purposes. For example, people play media, such as audio or video, using electronic devices. The media may be stored locally at an electronic device or transmitted to the electronic device. With the advent of high-bandwidth streaming capabilities, many people stream music, live radio, and podcasts to their electronic devices using Wi-Fi or cellular networks.

However, Wi-Fi hotspots are typically limited to areas in or near buildings. Further, Wi-Fi hotspots sometimes require a fee or a privileged login access, like a membership or separate purchase. Cellular networks tend to offer a greater coverage area than Wi-Fi hotspots and are adept at servicing electronic devices that are in motion, such as if a user is traveling or exercising. Unfortunately, cellular networks are bandwidth limited in the sense that additional streamed bytes cost additional funds, either on a per-byte basis or by pre-purchasing a larger bucket of bytes (e.g., paying “X” dollars per gigabyte (GB)). In view of these issues, it is good that electronic devices have another option for obtaining audio that does not require streaming from Wi-Fi or cellular networks. This other option is terrestrial radio.

Terrestrial radio includes, for example, frequency modulation (FM) signals that cover different portions of the electromagnetic spectrum in different countries across a range of 65 to 108 megahertz (MHz). For instance, the U.S. allocates 87.5 to 108.0 MHz to FM radio. This terrestrial radio option is attractive to many users of electronic devices for several reasons. It is an especially attractive option for broadcast radio because terrestrial radio is typically free. Additionally, radio signals can be received while an electronic device is in motion or is located in a remote area far from Wi-Fi hotspots or even cellular coverage. Further, listening to terrestrial radio can save battery power and enable a bandwidth allocation of a cellular data plan to be conserved. However, enabling an electronic device to receive terrestrial radio signals can be challenging.

### SUMMARY

In some situations, it is desirable to receive radio signals, such as commercial frequency-modulated (FM) radio signals, using an electronic device, like a smartphone or a smartwatch. With traditional analog audio headsets (e.g., headphones or earbuds), a left (L) audio line or a right (R) audio line can be simultaneously used as a frequency-modulated (FM) radio antenna. However, with a digital audio headset, digital data that is propagating on audio data lines can interfere with FM radio signal reception.

To address this problem, antenna and cabling unification is described herein. Example implementations employ a separate, partially floating, wire as a radio antenna that is included as part of a cabling apparatus. The antenna is coupled to a device connector of the cabling apparatus, and the device connector can be coupled to an associated electronic device. The antenna extends along a cable toward, but is not electrically coupled to, an audio endpoint on an end of the cabling apparatus that is opposite that of the device connector. In other example implementations, the antenna is shielded from other wires stretching along the cable, such as from digital data traffic on digital audio wires or from a power wire. In yet other example implementations, with a cabling apparatus that comports with a Universal Serial Bus (USB) Type-C architecture, the antenna can be coupled to at least one sideband use (SBU) pin of a device connector of the cabling apparatus. Further, an electronic device can use an antenna of such a cabling apparatus to receive a radio signal and then provide audio data on the cabling apparatus based on the received radio signal. In any one or more of these manners, a cabling apparatus can be used to support a radio operation that is provided by an associated electronic device. Moreover, other example implementations for antenna and cabling unification are described herein with respect to various apparatuses, systems, electronic devices, arrangements, methods, and so forth.

In an example aspect, an electronic device is disclosed. The electronic device includes a cabling connector, a digital interface, and a radio. The cabling connector includes multiple pins configured to couple the electronic device to a device connector of an external cabling apparatus. The multiple pins include a positive digital pin, a negative digital pin, and a first other pin. The digital interface includes a positive interface node and a negative interface node. The positive interface node is coupled to the positive digital pin, and the negative interface node is coupled to the negative digital pin. The radio includes an antenna node coupled to at least the first other pin.

In an example aspect, a method is disclosed. The method includes determining a first terminal node of multiple terminal nodes that is coupled to an antenna of a cabling apparatus. The multiple terminal nodes are coupled to a cabling connector of a mobile device that is connected to the cabling apparatus. The method also includes receiving a wireless signal from the antenna via the first terminal node. The method additionally includes converting the wireless signal to digital audio data. The method further includes transmitting the digital audio data over multiple audio wires of the cabling apparatus via a second terminal node and a third terminal node of the multiple terminal nodes.

In an example aspect, an apparatus is disclosed. The apparatus includes a device connector, an audio endpoint, and a cable. The device connector includes multiple terminal nodes. The audio endpoint includes multiple endpoint nodes. The cable is coupled between the device connector and the audio endpoint. The cable includes multiple wires and an antenna. The multiple wires are coupled between at least two respective nodes of the multiple terminal nodes of the device connector and at least two respective nodes of the multiple endpoint nodes of the audio endpoint. The antenna is coupled to at least one of the multiple terminal nodes of the device connector and uncoupled from the audio endpoint.

In an example aspect, an electronic device is disclosed. The electronic device includes means for coupling the electronic device to an external cabling apparatus. The electronic device also includes means for processing analog signals wirelessly received via an antenna, the means for processing analog signals being coupled to the means for coupling. The electronic device further includes means for providing digital audio data based on the analog signals wirelessly received via the antenna, the means for providing digital audio data being coupled to the means for processing analog signals and the means for coupling.

### BRIEF DESCRIPTION OF DRAWINGS

FIG. 1-1 illustrates an example environment including an electronic device and an example cabling apparatus that can implement antenna and cabling unification, with the cabling apparatus including a device connector, a cable, and an audio endpoint.

FIG. 1-2 illustrates an example environment including a cabling apparatus and an example electronic device that can implement antenna and cabling unification, with the electronic device including a cabling connector.

FIG. 2 illustrates an exploded view of an example cable portion of a cabling apparatus.

FIG. 3 illustrates a schematic view of an example cable portion of a cabling apparatus.

FIG. 4 illustrates a schematic view of an example device connector portion of a cabling apparatus, including an example implementation that comports with a Universal Serial Bus (USB) Type-C architecture.

FIG. 5 illustrates an example cabling apparatus in which the audio endpoint is implemented as a digital headset apparatus and the cable portion includes an antenna.

FIG. 6 illustrates an example cabling apparatus in which the audio endpoint is implemented as an analog audio adapter socket and the cable portion includes an antenna.

FIG. 7 illustrates an example electronic device including a cabling connector, switching circuitry, and a connector interface controller for antenna and cabling unification.

FIG. 8 is a flow diagram illustrating an example process for antenna and cabling unification that can be performed by an electronic device that is coupled to a cabling apparatus as described herein.

FIG. 9 illustrates an example electronic device that includes a cabling connector, switching circuitry, and a connector interface controller to implement antenna and cabling unification as described herein

[symbol]

### DETAILED DESCRIPTION

Although many users of electronic devices choose to stream audio digitally over a Wi-Fi or cellular connection, listening to terrestrial radio is also attractive to many users. This is especially true for receiving live or local broadcast radio, for saving battery power, or for reducing bandwidth usage on metered cellular plans. Unfortunately, integrating broadcast radio usage with digital electronic devices presents a number of problems. For example, portable electronic devices are usually smaller than a typical frequency modulation (FM) radio antenna. Further, the propagation of digital audio data can interfere with the reception of radio frequency (RF) wireless signals, such as those of FM wireless signals.

Consider, for instance, the use of digital headsets that utilize a Universal Serial Bus (USB) connector, such as a USB Type-C connector. With a USB digital connector, the digital USB packet traffic, which includes audio data, can de-sense a sensitive FM reception. If an FM antenna is located proximate to a cable that is coupled to a digital headset, such as by being extended along a length of the cable, the FM antenna is exposed to the digital USB packet traffic. Unfortunately, a wireline FM antenna cannot be easily accommodated within a housing of a portable electronic device because the required antenna size is too large.

In the context of FM radio, an antenna that is long relative to those used in Wi-Fi and cellular communications is employed. This is because commercial FM broadcasting stations typically operate on a lower frequency (e.g., the 76-108 Megahertz (MHz) frequency range) than those used for cellular radios (e.g., which can start around 700 MHz and reach into the gigahertz (GHz) frequency range). For example, much of the world devotes 87.5 to 108 MHz to commercial FM radio signals, and Japan assigns 76 to 95 MHz to commercial FM radio signals. An effective antenna for this frequency band includes, for instance, a monopole having a length of approximately one quarter of a wavelength of the signal, which is about 76 cm or 2.5 feet. Thus, an antenna for receiving terrestrial FM radio signals is typically approximately 30 inches long.

Consequently, incorporating an FM radio antenna directly into a smartphone, for example, is prohibitively difficult due to the size differential between a smartphone form factor that is 4 to 6 inches (4-6″) along a given dimension and an antenna that is over two feet long. To address this size difference, one approach to providing an FM radio antenna to an electronic device having a relatively small form factor is to leverage a wired cord extending between the electronic device and a headset, such as pair of headphones, earphones, or earbuds. For example, one of the analog audio lines (e.g., the left (L) audio line or the right (R) audio line) leading to an analog headset can be used, or shared, as the FM radio antenna. However, with the emergence of all-digital headsets, this has become problematic.

Consider a digital headset that comports, for example, with a multipurpose USB Type-C protocol. Sharing one of the digital audio data lines as an FM antenna is not feasible because the digital USB data packets propagating between the electronic device and a digital interface in the headset generate electromagnetic (EM) noise. This EM noise at least adversely impacts, and can substantially cover, the FM frequency band. The EM noise therefore interferes with the wireless reception of FM radio signals.

In contrast, example approaches as described herein employ a separate wire line as an antenna in a cable extending from a device connector to an audio endpoint. The device connector, the cable, and the audio endpoint can jointly form a cabling apparatus. In operation, the device connector is coupled to an electronic device via a cabling connector thereof, and the audio endpoint provides at least an audio output, such as a digital headset or an analog adapter. In some cabling apparatus implementations, the antenna is coupled to the device connector on one end and is left floating with respect to the other end. In other words, the antenna can be uncoupled from the audio endpoint. In other implementations, the antenna is electromagnetically separated from multiple other wires using a shielding component (e.g., by isolating the multiple wires). The multiple wires, such as audio wires or a power wire, extend from the device connector to the audio endpoint and can be enclosed within a shielding layer. In still other implementations, an antenna disposed along a cable portion of a cabling apparatus can be coupled to a device connector but uncoupled from an audio endpoint while also being shielded from the EM signaling occurring along multiple wires disposed along the cable portion.

In example electronic device implementations, an electronic device includes switching circuitry and a connector interface controller to operate with a cabling apparatus as described herein. The switching circuitry is coupled to a cabling connector, which can be coupled to a device connector of the cabling apparatus. The switching circuitry includes multiple terminal nodes, at least some of which are individually coupled to respective ones of multiple wires and an antenna of a cable portion of the cabling apparatus via the cabling connector. The connector interface controller can determine which terminal node of multiple terminal nodes is coupled to the antenna and can activate at least one switch of the switching circuitry to route FM radio signals from the antenna to an FM receiver of the electronic device.

In some example implementations, a cabling apparatus comports with a USB Type-C standard. A device connector of a cabling apparatus includes multiple terminal nodes that are coupled both to a cable of the cabling apparatus and to multiple pins (e.g., interface or connection pins). The pins of the device connector are configured to be connected to a cabling connector of an electronic device, which likewise comports with the USB Type-C standard. Thus, the device connector couples the multiple terminal nodes to the pins, and the pins comport with a USB Type-C connection standard. In such an implementation, an antenna of the cable can be coupled to at least one of two specific pins of a USB Type-C connector. For instance, the antenna can be coupled to at least one sideband use (SBU) pin (e.g., a first sideband use (SBU1) pin or a second sideband use (SBU2) pin), as is explained herein below.

In these manners, a cabling apparatus that is designed for digital signal propagation can include an antenna for use with terrestrial radio, such as FM radio. A partially floating antenna wire can be shielded from other wires that carry digital audio data or power to enable the antenna to be sensitive to wireless radio signals. Further, the cabling apparatus can be implemented to comport with a USB Type-C connector by selectively coupling the antenna to a particular pin of a USB Type-C connector, such as an SBU pin. An electronic device can be configured to interface with a cabling apparatus and utilize the antenna thereof for radio reception.

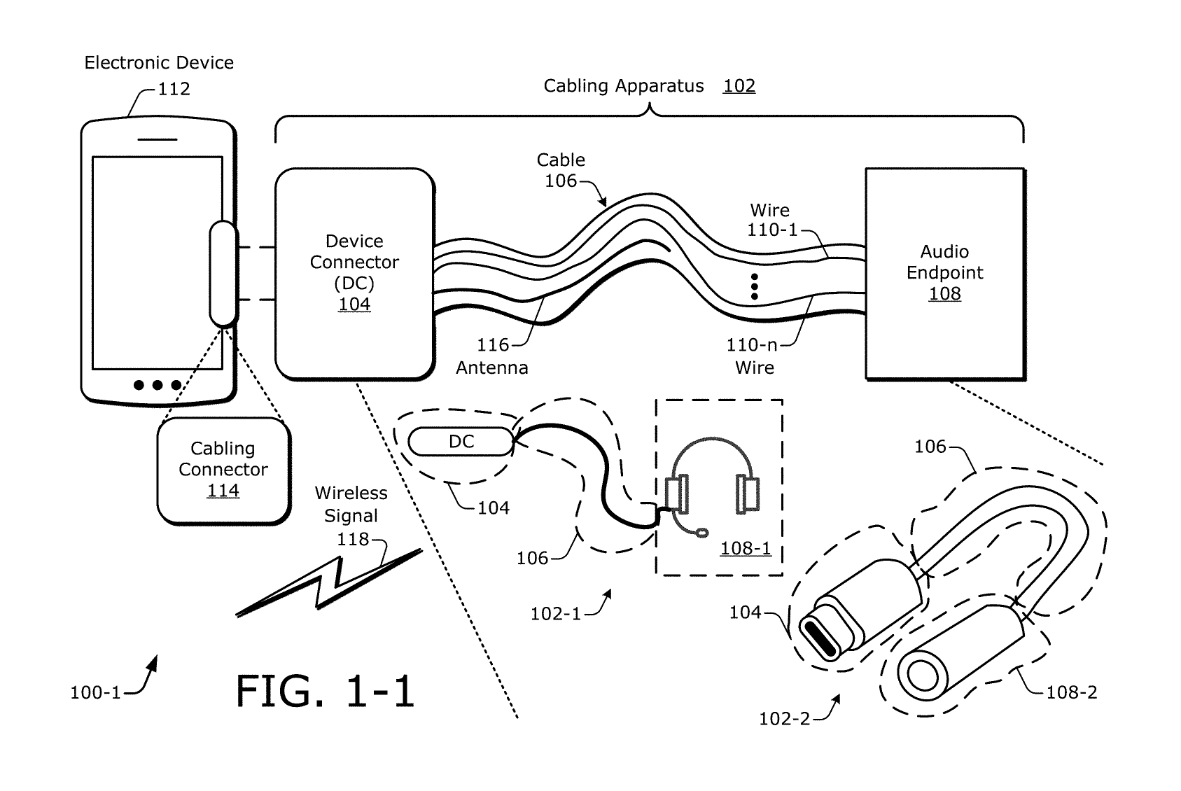

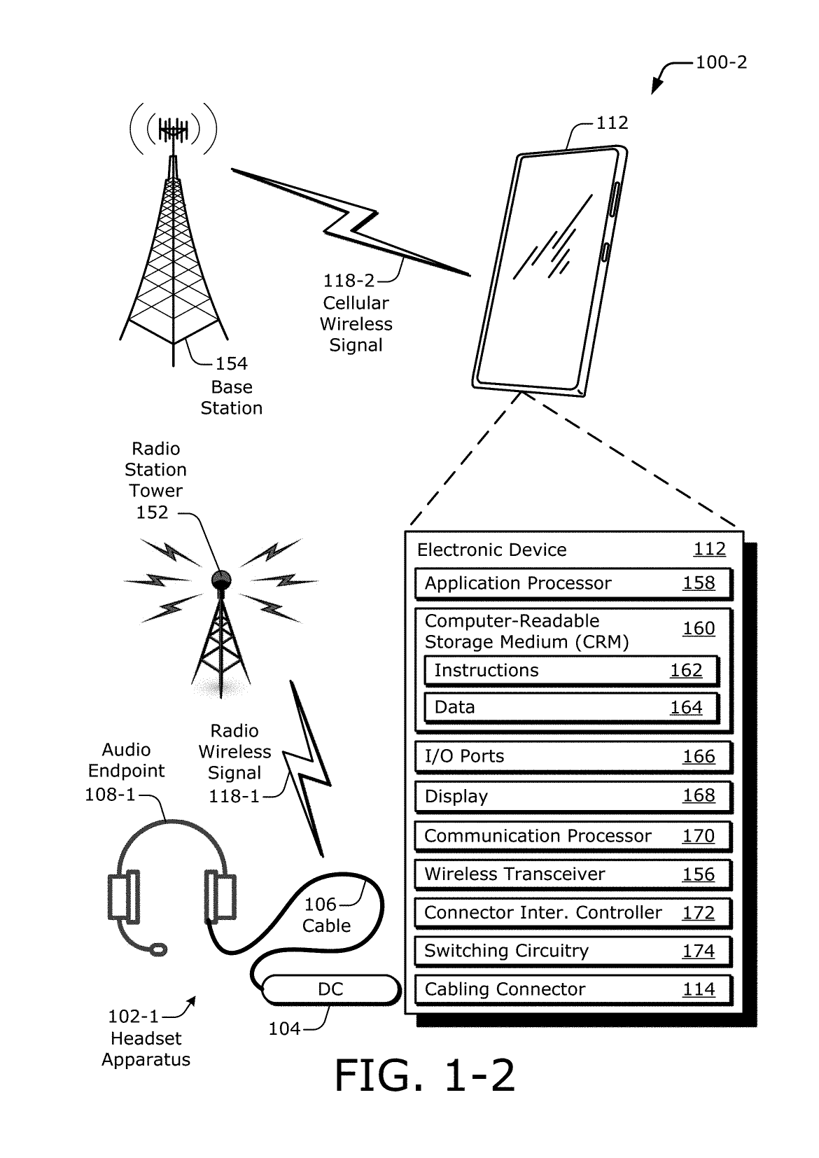

FIG. 1-1 illustrates an environment 100-1 including an electronic device 112 and an example cabling apparatus 102 that can implement antenna and audio cabling unification. As shown, the cabling apparatus 102 includes a device connector 104, a cable 106, and an audio endpoint 108. The electronic device 112 includes a cabling connector 114. The cabling connector 114 mates to the device connector 104 such that the cable 106 or the audio endpoint 108 is communicatively coupled to the electronic device 112. For example, the cabling connector 114 can be implemented as a receptacle, and the device connector 104 can be implemented as a plug. In some implementations, the cabling connector 114 and the device connector 104 may be configured in a form that complies with a USB Type-C connection standard. Also, although shown as an audio endpoint 108, an endpoint of the cabling apparatus 102 can alternatively be realized with functionalities other than, or in addition to, those involving audio.

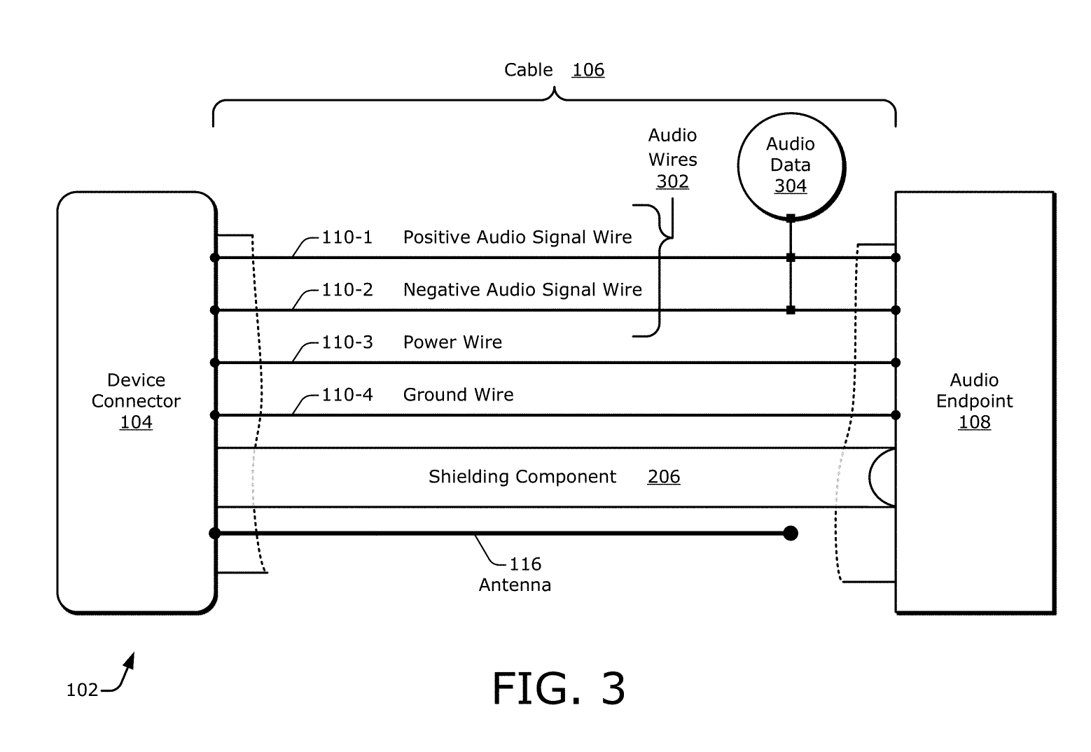

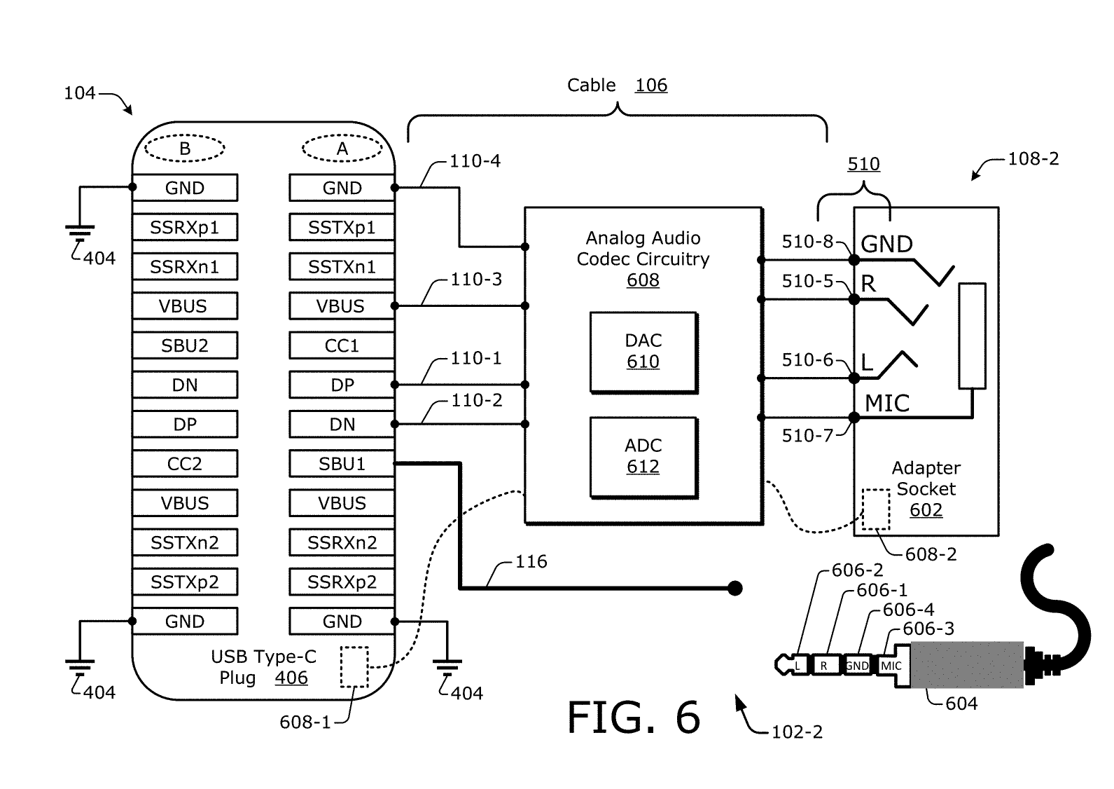

In example implementations, the cable 106 extends from the device connector 104 to the audio endpoint 108. The cable 106 includes multiple wires 110-1 to 110-n, with “n” representing some positive integer. The multiple wires 110-1 to 110-n include at least multiple audio wires and at least one power wire, as is described below with reference to FIG. 3. The multiple wires 110-1 to 110-n extend from the device connector 104 to the audio endpoint 108. Thus, the multiple wires 110-1 to 110-n are coupled to the device connector 104 and the audio endpoint 108. The cable 106 also includes at least one antenna 116. The antenna 116 can be, for example, configured or tuned to radiate at a frequency of a broadcast FM radio station, such as 76 to 108 MHz for commercial FM radio broadcasts in many countries. Accordingly, the antenna 116 can have a length that is, for instance, one-quarter to one-half a size of a wavelength of the signal to be received. For a 76 to 108 MHz frequency signal range, a corresponding wire length range is 2 to 4 feet. Although 3 to 4 feet may provide superior reception, a length of a wireline antenna can range between 24 and 36 inches to match a length of cable linking a device connector to a headset connection for the convenience of an end-user. However, other antenna lengths can alternatively be used. Further, a discrete chip antenna can be used instead as described below with particular reference to FIG. 6.

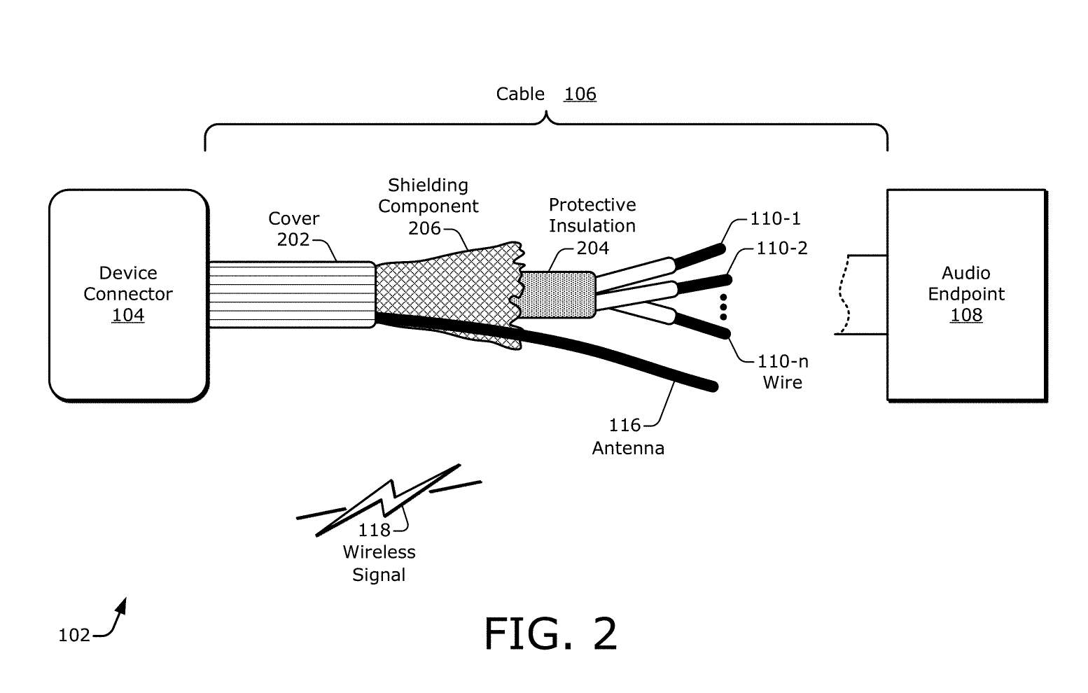

Although the antenna 116 has one end coupled to the device connector 104, an opposite end of the antenna 116 can be floating—e.g., electrically uncoupled from the audio endpoint 108. This arrangement enables the antenna 116 to receive and be electrically excited by propagating EM wireless signals, such as those for FM radio, as represented by a wireless signal 118. The antenna 116 can then propagate a radio frequency (RF) signal to the device connector 104. Thus, the antenna 116 can provide at least one radiation mechanism for propagating at least one wireless signal 118 to the device connector 104. The multiple wires 110-1 to 110-n, the antenna 116, the connectors, the endpoints, and so forth are not necessarily depicted to scale in the various figures. As shown in FIG. 1-1 (e.g., and FIG. 1-2), the cabling apparatus 102 is disposed external to the electronic device 112. The cabling apparatus 102 can be external to the electronic device 112 if, for example, the cabling apparatus 102 is disposed outside of a housing (e.g., a metal, plastic, or glass frame or casing) of the electronic device 112, the cabling apparatus 102 can be connected to or disconnected from (e.g., is removably couplable to) the electronic device 112 by an end-user (e.g., without disassembling the electronic device 112), and so forth. Thus, the cabling apparatus 102 can comprise an external cabling apparatus 102.

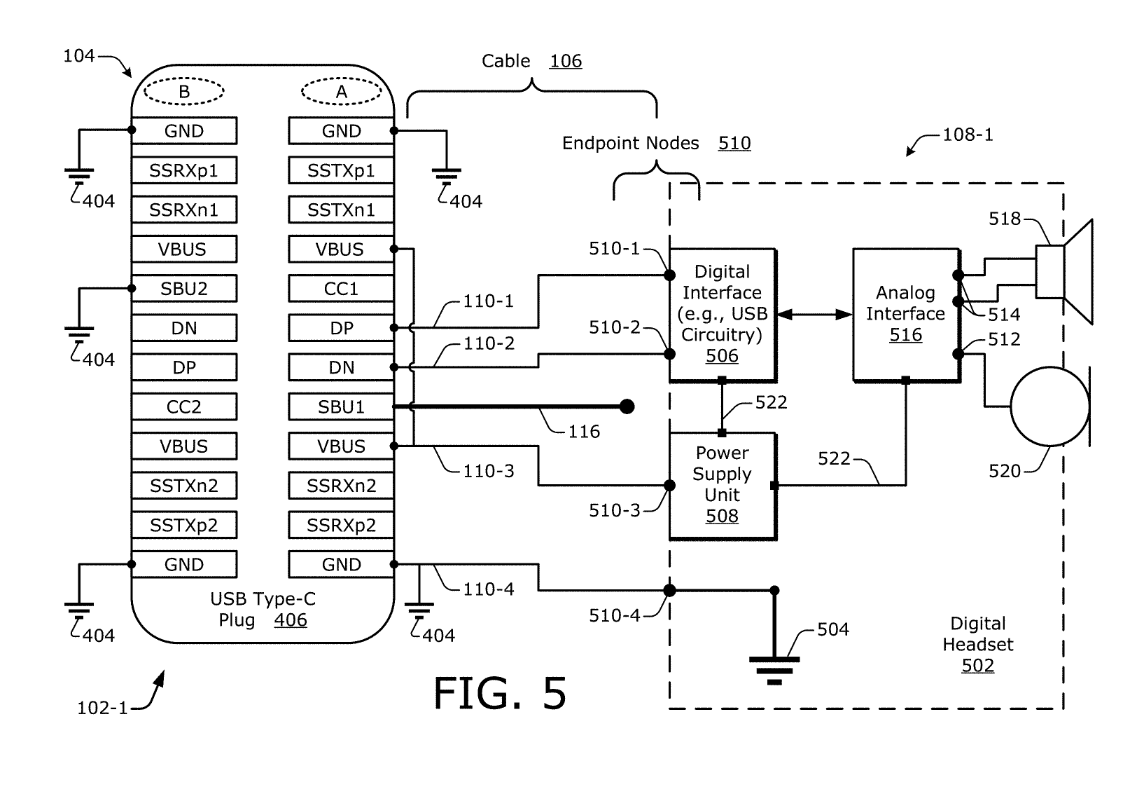

The cabling apparatus 102 can be realized in many different manners, with two examples depicted in dashed lines as a first cabling apparatus 102-1 and a second cabling apparatus 102-2. Accordingly, an audio endpoint 108 can be realized in multiple different manners. For example, the audio endpoint 108 can be realized as an integrated headset 108-1 such that the first cabling apparatus 102-1 forms a headset apparatus. Example implementations for headset apparatuses are described below with reference to FIG. 5. Alternatively, an audio endpoint 108 can be realized as an audio jack 108-2, such as an analog audio jack. Thus, as shown in conjunction with the audio jack 108-2 and the second cabling apparatus 102-2, but by way of example only, a cabling apparatus 102 can be implemented as an adapter (e.g., between a digital device and an analog headset). The adapter functionality is provided between the cabling connector 114, which has a digital interface for the electronic device 112, and an analog headset (not explicitly shown) by using the device connector 104 and the cable 106 in conjunction with the audio jack 108-2. In such cases, an audio codec (not shown in FIG. 1-1) can be included as part of the cabling apparatus 102-2. Example implementations for adapter apparatuses are described below with reference to FIG. 6.

FIG. 1-2 illustrates an example environment 100-2 that includes an example electronic device 112 in which antenna and cabling unification can be implemented. In the environment 100-2, the electronic device 112 can communicate with a base station 154 via a cellular wireless signal 118-2 or with a radio station tower 152 via a radio wireless signal 118-1. As shown in the top portion of FIG. 1-2, the electronic device 112 communicates with the base station 154 through a wireless communication link as represented by the cellular wireless signal 118-2. In this example, the electronic device 112 is depicted as a smart phone. However, the electronic device 112 may be implemented as any suitable computing or other electronic device, such as a broadband router, access point, cellular or mobile phone, gaming device, navigation device, media device, laptop computer, desktop computer, tablet computer, server, network-attached storage (NAS) device, smart appliance, vehicle-based communication system, Internet-of-Things (IoT) device, wearable device, entertainment appliance, streaming device for audio or video, circuit board or chipset, and so forth.

The base station 154 communicates with the electronic device 112 via the cellular wireless signal 118-2, which may be implemented as any suitable type of wireless link. Although depicted as a base station tower of a cellular radio network, the base station 154 may represent or be implemented as another device, such as a satellite, access point, peer-to-peer device, mesh network node, fiber optic line, server device, another electronic device generally, and so forth. Hence, the electronic device 112 may communicate with the base station 154 or another device via a wired connection, a wireless connection, or a combination thereof.

The cellular wireless signal 118-2 can include a downlink of data or control information communicated from the base station 154 to the electronic device 112 and an uplink of other data or control information communicated from the electronic device 112 to the base station 154. The cellular wireless signal 118-2 may be implemented using any suitable communication protocol or standard, such as 3rd Generation Partnership Project Long-Term Evolution (3GPP LTE). Alternatively, a communication between the electronic device 112 and the base station 154 can comport with a Wi-Fi or other wireless standard, such as IEEE 802.11, IEEE 802.16, Bluetooth™, and so forth.

As shown, the electronic device 112 includes a processor 158 and a computer-readable storage medium 160 (CRM 160). The processor 158 may include any type of processor, such as an application processor or a multi-core processor, that is configured to execute processor-executable instructions (e.g., code) stored by the CRM 160. The CRM 160 may include any suitable type of data storage media, such as volatile memory (e.g., random access memory (RAM)), non-volatile memory (e.g., Flash memory), optical media, magnetic media (e.g., disk or tape), memory with hard-coded instructions, and so forth. In the context of this disclosure, the CRM 160 is implemented to store instructions 162, data 164, and other information of the electronic device 112, and thus does not include transitory propagating signals or carrier waves.

The electronic device 112 may also include input/output ports 166 (I/O ports 166) or a display 168. The I/O ports 166 enable data exchanges or interaction with other devices, networks, or users. The I/O ports 166 may include serial ports (e.g., universal serial bus (USB) ports), parallel ports, audio ports, infrared (IR) ports, and so forth. Thus, in some implementations, the I/O ports 166 can include at least one cabling connector 114 to accept a device connector 104. The display 168 can be realized as a screen or projection that presents graphics of the electronic device 112, such as a user interface associated with an operating system, program, or application. Alternatively or additionally, the display 168 may be implemented as a display port or virtual interface through which graphical content of the electronic device 112 is communicated or presented.

For two-way or bi-directional communication purposes, the electronic device 112 also includes a communication processor 170, a wireless transceiver 156, and an antenna (not shown) that is internal to, or a part of, a housing of the electronic device 112. The wireless transceiver 156 provides connectivity to respective networks and other electronic devices connected therewith using radio-frequency (RF) wireless signals. Additionally or alternatively, the electronic device 112 may include a wired transceiver, such as an Ethernet or fiber optic interface for communicating over a personal or local network, an intranet, or the Internet. The wireless transceiver 156 may facilitate bi-directional communication over any suitable type of wireless network, such as a wireless local area network (LAN) (WLAN), a peer-to-peer (P2P) network, a mesh network, a cellular network, a wireless wide-area-network (WWAN), or a wireless personal-area-network (WPAN). In the context of the example environment 100-2, the wireless transceiver 156 enables the electronic device 112 to communicate with the base station 154 and networks connected therewith or “directly” with other electronic devices. Although not explicitly shown in FIG. 1-2, the electronic device 112 may also include a wireless receiver to access a navigational network (e.g., the Global Positioning System (GPS) of North America or another Global Navigation Satellite System (GNSS)).

The communication processor 170 may be realized as a communication-oriented processor, such as a baseband modem. The communication processor 170 may be implemented as a system on-chip (SoC) that provides a digital communication interface for data, voice, messaging, and other applications of the electronic device 112. The communication processor 170 may also include baseband circuitry to perform high-rate sampling processes that can include analog-to-digital conversion (ADC), digital-to-analog conversion (DAC), gain correction, skew correction, frequency translation, and so forth. The communication processor 170 may also include logic to perform in-phase/quadrature (I/Q) operations, such as synthesis, encoding, modulation, demodulation, and decoding. More generally, the communication processor 170 may be realized as a digital signal processor (DSP) or a processor that is configured to perform signal processing to support communication via one or more networks. Alternatively, ADC or DAC operations may be performed by a separate component or another illustrated component, such as the wireless transceiver 156.

The wireless transceiver 156 can include circuitry, logic, and other hardware for transmitting and receiving a wireless signal for at least one communication frequency band. In operation, the wireless transceiver 156 can implement at least one, e.g., radio-frequency transceiver unit to process data and/or signals associated with communicating data of the electronic device 112. Generally, the wireless transceiver 156 can include filters, switches, amplifiers, and so forth for routing and conditioning signals that are transmitted from and received at the electronic device 112 via the cellular wireless signal 118-2. In some cases, components of the wireless transceiver 156 are implemented as separate receiver and transmitter entities. Additionally or alternatively, the wireless transceiver 156 can be realized using multiple or different sections to implement respective receiving and transmitting operations (e.g., using separate transmit and receive chains).

As illustrated, the environment 100-2 also includes a radio station tower 152. The radio station tower 152 transmits (e.g., broadcasts) at least one radio wireless signal 118-1. In some implementations, the radio wireless signal 118-1 is transmitted in the 50 MHz to 150 MHz range, such as the 76 to 108 MHz range for commercial FM radio broadcasts in many countries. Accordingly, some effective lengths for monopole antennas to receive these transmissions are 2-3 feet, which is too long to efficiently incorporate directly into the electronic device 112. In such situations, a wire that is part of a cabling apparatus 102 (e.g., a headset apparatus 102-1) can be used as an antenna 116 (e.g., of FIG. 1-1, 2, or 3).

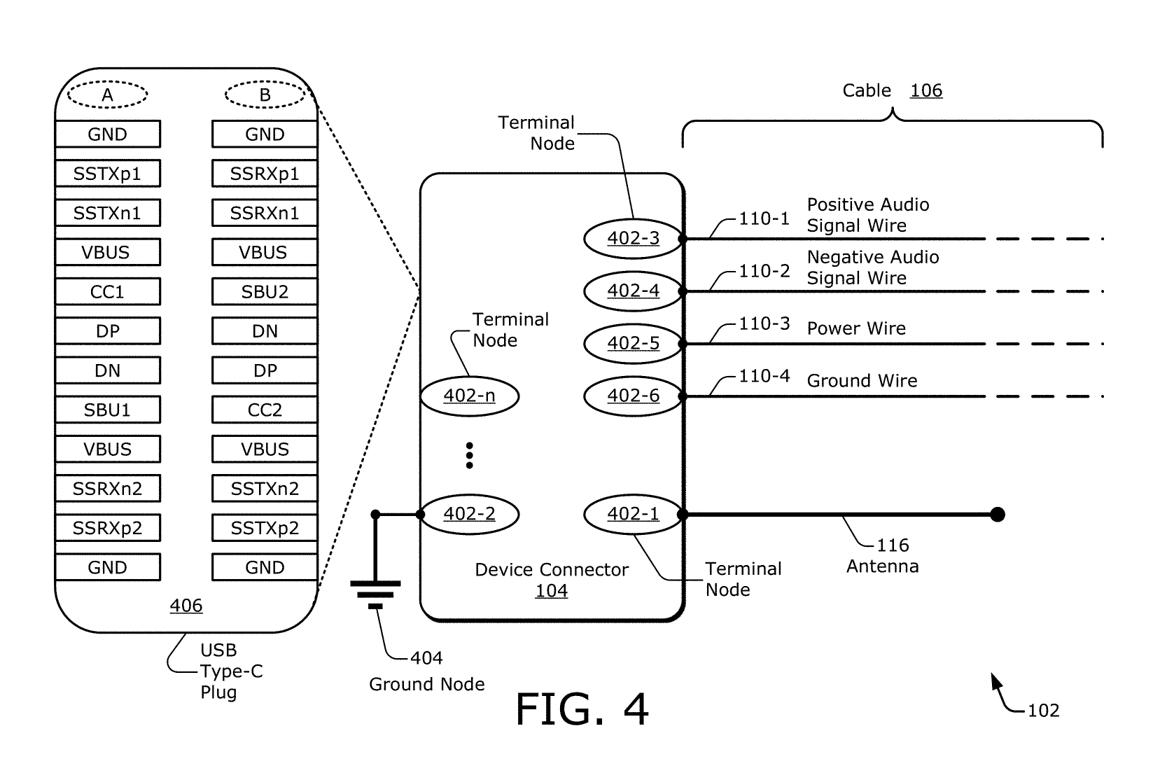

Thus, FIG. 1-2 depicts a headset apparatus 102-1 as an example cabling apparatus 102. The headset apparatus 102-1 includes an audio endpoint 108-1 that comprises a headset, a cable 106, and a device connector 104 (DC 104). The audio endpoint 108-1 can include at least one speaker, at least one microphone, and so forth. The audio endpoint 108-1 can be realized as headphones, earphones, earbuds, and the like. The microphone, if present, can alternatively be disposed somewhere along the cable 106. The cable 106 extends from the audio endpoint 108-1 to the device connector 104 and is coupled to both. As shown, the device connector 104 can comprise a male interface, such as plug that comports with a USB Type-C protocol and is configured to be inserted into a receptacle of the electronic device 112 that also comports with a USB Type-C protocol as described below with reference to FIG. 4.

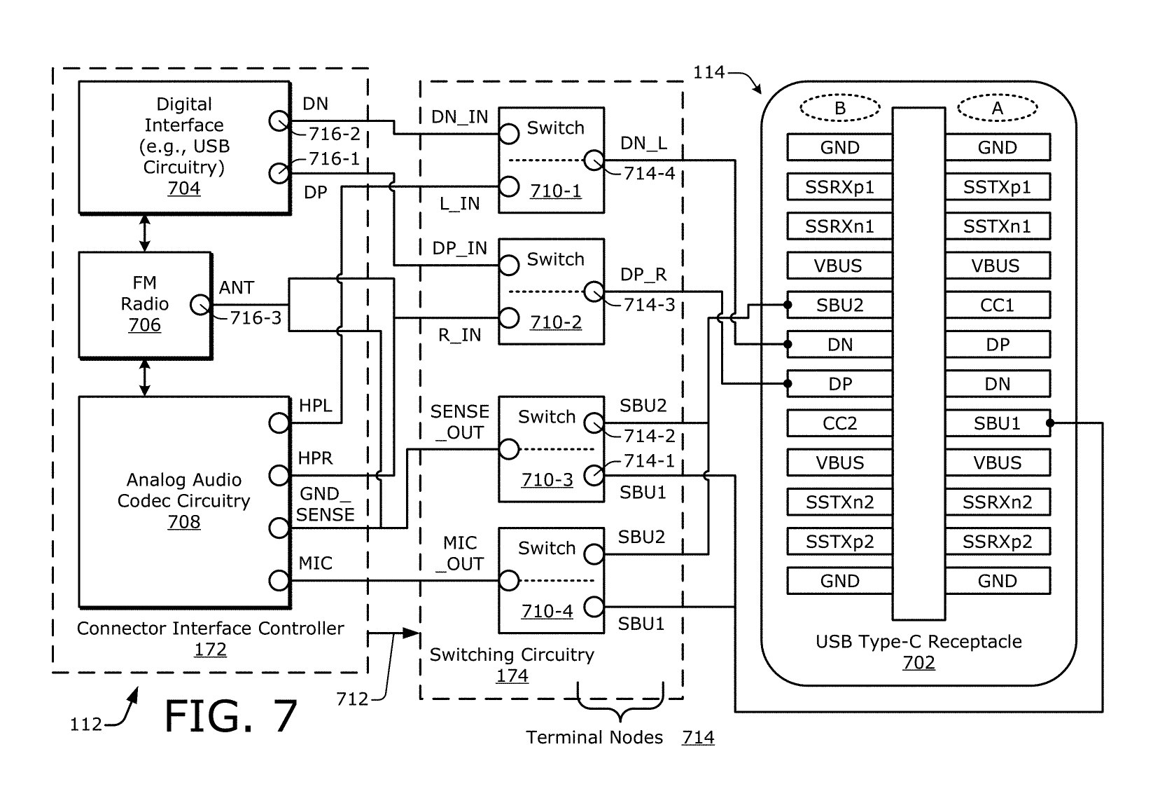

In example implementations, the electronic device 112 also includes components to receive or facilitate reception of radio wireless signals, such as the radio wireless signal 118-1. These components can include, in addition to the communication processor 170, a connector interface controller 172, switching circuitry 174, and a cabling connector 114. The switching circuitry 174 is coupled between the cabling connector 114 and the connector interface controller 172. The connector interface controller 172 can include, or can be communicatively coupled to, a radio receiver, an analog audio codec, and so forth, as described below with reference to FIG. 7. The connector interface controller 172 includes logic to control the switching circuitry 174 based on a device connector 104 that is inserted into the cabling connector 114. The cabling connector 114 can comprise a female interface or receptacle that is configured to accept the device connector 104 to establish an electrical connection therebetween across one or more pins (e.g., contacts) (not shown in FIG. 1). These pins can comport with a USB Type-C protocol as described with reference to FIGS. 4 and 7. The connector interface controller 172, the switching circuitry 174, and the cabling connector 114 can individually or jointly be configured to enable the electronic device 112 to operate with an apparatus implementing antenna and cabling unification.

FIG. 2 illustrates an exploded view of an example cable 106 of a cabling apparatus 102. As shown, the cable 106 includes multiple wires 110-1 to 110-n and an antenna 116, with “n” representing some integer. Thus, although three wires 110-1, 110-2, and 110-n are explicitly depicted, more or fewer wires may alternatively be implemented. For example, four (as illustrated in subsequent figures) or more wires may be implemented as the multiple wires 110. In some implementations, the cable also includes at least one of a shielding component 206, protective insulation 204, or a cover 202. The cover 202 encases internal parts of the cable 106 and can repel liquids or dirt. The protective insulation 204 provides physical cushioning and mechanical resiliency to protect the multiple wires 110-1 to 110-3 and the antenna 116 of the cable 106.

The shielding component 206 provides electromagnetic (EM) shielding to at least partially protect the antenna 116 from EM radiation, such as by substantially blocking or isolating the EM radiation generated by the multiple wires 110-1 to 110-3 from the antenna 116. For example, the shielding component 206 can be interposed between the antenna 116 and at least a portion of the multiple wires 110-1 to 110-3 to block EM radiation at least for frequencies at or around those for which the antenna 116 is expected to receive signals (e.g., 76-108 MHz for an FM radio broadcast). The shielding component 206 can be formed from any material that blocks or appreciably attenuates EM radiation, such as a braided metal sleeve. Consequently, digital data, including audio digital data, that is propagating along one or more of the multiple wires 110-1 to 110-3 does not adversely affect the ability of the antenna 116 to receive or be electrically excited by a wireless signal 118, at least not to an appreciable degree that prevents reception and demodulation of a desired radio signal. Thus, the shielding component 206 can provide at least one mechanism for shielding at least one wireless signal, which is being propagated along the antenna 116 to the device connector 104, from at least one audio signal propagating along audio wires of the multiple wires 110-1 to 110-3. The shielding component 206 may also isolate the multiple wires 110-1 to 110-3 from radiation originating from a source other than the wires 110.

In example implementations, the shielding component 206 is realized as a shielding layer. As shown, particularly in the example depicted in FIG. 2, the shielding component 206 can be implemented as a cylindrical shielding layer or tube that wraps around and encloses the multiple wires 110-1 to 110-3 to electromagnetically isolate these wires from the antenna 116. However, the shielding component 206 can alternatively be implemented in a different shape or form while still providing at least a partial EM barrier between the multiple wires 110-1 to 110-3, which may be radiating RF interference, and the antenna 116. Although the cable 106 is depicted with a certain complement of parts arranged in a particular manner, the cabling apparatus 102 can be implemented in alternative manners. For example, the protective insulation 204 can be omitted, the cable 106 can be flat or oval, one or more of the multiple wires 110-1 to 110-3 can be individually shielded with respect to the antenna 116 or other external factors instead of being bundled together, the protective insulation 204 can surround the shielding component 206 and the antenna 116 as well as the multiple wires 110-1 to 110-3, and so forth.

FIG. 3 illustrates a schematic view of an example cable 106 of the cabling apparatus 102. As shown, the cable 106 includes multiple wires 110-1 to 110-4, the antenna 116, and the shielding component 206. Although four wires 110-1, 110-2, 110-3, and 110-4 are explicitly depicted, more or fewer wires may alternatively be implemented. For example, the cable 106 may include other types of wires (e.g., non-data wires or non-audio wires), duplicate instances of the depicted wires, and so forth. The shielding component 206 provides an electromagnetic shield to protect the antenna 116 from electromagnetic radiation generated by any one or more of the multiple wires 110-1 to 110-4.

In example implementations, the cable 106 includes four wires 110-1 to 110-4: a positive audio signal wire 110-1, a negative audio signal wire 110-2, a power wire 110-3, and a ground wire 110-4. In FIG. 3, the positive audio signal wire 110-1 (e.g., the positive digital audio data signal wire) and the negative audio signal wire 110-2 (e.g., the negative digital audio data signal wire) are indicated as multiple audio wires 302. However, in alternative implementations, other wires pertaining to the audio endpoint 108 may be included as part of the multiple audio wires 302. For example, the power wire 110-3 that provides power to an audio endpoint 108 or the ground wire 110-4 may be audio-related. Also, although indicated as audio wires 302, the depicted multiple wires 110-1 to 110-4 or other wires 110 of the cabling apparatus 102 can alternatively be utilized with functionalities other than, or in addition to, those involving audio. The wires may therefore be referred to more generally as data wires or data signal wires, and may for example, be configured as a data positive (D+ or DP) wire and a data negative (D− or DN) wire for differential signaling. Further, one or more wires, such as the power wire 110-3 or the ground wire 110-4, may be disposed outside of the shielding component 206, such as by being adjacent to the antenna 116.

The antenna 116 is coupled to the device connector 104 but is uncoupled from the audio endpoint 108. In contrast, the multiple wires 110-1 to 110-4 extend between and are coupled to both the device connector 104 and the audio endpoint 108. In operation, at least one audio signal wire propagates audio data 304 between the device connector 104 and the audio endpoint 108 in either or both directions. For example, the positive audio signal wire 110-1 and the negative audio signal wire 110-2 can both propagate a signal carrying audio data 304 (e.g., sounds, music, or speech). If the audio endpoint 108 is functioning as a speaker, the positive audio signal wire 110-1 or the negative audio signal wire 110-2 propagates (e.g., individually or jointly) audio data 304 from the device connector 104 to the audio endpoint 108 for presenting aurally at the audio endpoint 108. If the audio endpoint 108 is functioning as a microphone, the positive audio signal wire 110-1 or the negative audio signal wire 110-2 propagates (e.g., individually or jointly) audio data 304 from the audio endpoint 108 to the device connector 104 for processing by the electronic device 112 (e.g., of FIGS. 1-1, 1-2, and 7). In some implementations, the audio endpoint 108 functions as both a microphone and a speaker, for example when the electronic device 112 is configured to process audio input from the audio endpoint 108 and generate noise cancellation information for use by an audio output of the audio endpoint 108 or for full duplex communications.

In some implementations, the positive audio signal wire 110-1 and the negative audio signal wire 110-2 form a differential signal pair that can propagate a differential signal between the device connector 104 and the audio endpoint 108. For instance, the positive audio signal wire 110-1 can propagate a positive or plus portion of a differential signal, and the negative audio signal wire 110-2 can propagate a negative or minus portion of the differential signal. The differential signal can be implemented as a digital differential signal to propagate digital audio data 304. In operation, the power wire 110-3 provides power to the audio endpoint 108 by receiving a supply voltage from the electronic device 112 via the device connector 104 and distributing the supply voltage to the audio endpoint 108. The ground wire 110-4 provides a distribution mechanism for a ground potential of a ground node of the electronic device 112 or of a combined system including the electronic device 112 and the cabling apparatus 102. The ground potential can provide a reference for the supply voltage.

In some implementations, one or more of the wires 110-1 to 110-4 are omitted. In an extreme example, all four of such wires are omitted. Further, the audio endpoint 108 can also be omitted or implemented as an endcap that does not include an electrically active component. Such an implementation can provide an end-user with an antenna 116, such as an FM antenna, that may be added to an electronic device 112 even if no other components (or wires) are being physically coupled to the electronic device 112 via the device connector 104 at that time with that cabling apparatus 102. In some such implementations, the antenna is implemented in a cable or cord. In other such implementations, the antenna is implemented in a case or cover that the user may attached to an electronic device 112. In addition to the case or cover having a device connector 104 to couple to a cabling connector 114 of an electronic device 112, the case or cover may itself have a cabling connector 114 configured to accept a connector similar to connect 104 from other apparatuses.

FIG. 4 illustrates a schematic view of an example device connector 104 of the cabling apparatus 102, including an example implementation that comports with a Universal Serial Bus (USB) Type-C architecture. The device connector 104 includes multiple terminal nodes 402-1 to 402-n, with “n” representing some positive integer. Of these “n” terminal nodes 402-1 to 402-n, six example terminal nodes are specifically depicted in FIG. 4. A first terminal node 402-1 is coupled to the antenna 116, and a second terminal node 402-2 is coupled to a ground node 404. A third terminal node 402-3 is coupled to the positive audio signal wire 110-1, and a fourth terminal node 402-4 is coupled to the negative audio signal wire 110-2. A fifth terminal node 402-5 is coupled to the power wire 110-3, and a sixth terminal node 402-6 is coupled to the ground wire 110-4. Thus, the second terminal node 402-2 and the sixth terminal node 402-6 can both be coupled to the ground node 404 in some implementations.

It is noted that particular numerical terms such as “first,” “second,” “third,” and so forth may be used to differentiate like components or aspects within a given context for clarity. However, in a different context, a same numerical term may refer to a different component or aspect, or a same component or aspect may have a different numerical identifier for the different context. Thus, a second terminal node may be coupled to ground in one context but coupled to an audio signal wire in another context as indicated in the other context.

In an example operation, these multiple terminal nodes 402-1 to 402-n of the device connector 104 are matched to a corresponding set of multiple terminal nodes at the cabling connector 114 (e.g., of FIGS. 1-1, 1-2, and 7) of the electronic device 112 via one or more input/output pins for each connector. In some implementations, the device connector 104 or the cabling connector 114 may comport with a USB standard, such as a USB Type-C connection specification. In an example USB Type-C connection implementation, the variable “n” represents 24, for there are 24 pins in a USB Type-C connection. Thus, within the device connector 104, each respective terminal node 402 from the cabling side is coupled to a respective pin that comports with a USB Type-C connection on the device side.

An example USB Type-C plug 406 that comports with a Universal Serial Bus (USB) specification for a Type-C connector is depicted in FIG. 4. The USB Type-C plug 406 includes 24 pins arranged in two columns identified as “A” or “B” (where the two columns can be two rows in a different orientation). Four pins can correspond to a ground return (GND), and four pins can correspond to voltage-supplied bus power (VBUS). Eight pins can correspond to “super-speed” differential communication lines for transmission or reception with two differential RX/TX pairs of such pins (SSTXp1, SSTXn1, SSRXp1, SSRXn1, SSRXn2, SSRXp2, SSTXn2, and SSTXp2, due to the reversal feature of the connector). Additionally, four pins can correspond to differential signaling with one differential pair of such pins (DP, DN, DN, and DP, due to the reversal feature of the connector). Two pins can correspond to a configuration channel (CC1 and CC2). And two pins can correspond to “sideband use” (SBU1 and SBU2). Thus, the USB Type-C plug 406 can provide at least one connection mechanism for comporting with a Universal Serial Bus (USB) Type-C protocol.

Further, the six illustrated terminal nodes 402-1 to 402-6 can be implemented using particular instances of the pins specified for a USB Type-C connection. For example, the first terminal node 402-1 that is tied to the antenna 116 can correspond to, or be coupled to, a first sideband use contact (e.g., an SBU1 or SBU_A pin). The second terminal node 402-2 that is tied to the ground node 404 can correspond to, or be coupled to, a second sideband use contact (e.g., an SBU2 or SBU_B pin). Alternatively, the sideband use pins (SBU1 and SBU2) can be swapped such that the first terminal node 402-1 that is tied to the antenna 116 corresponds to the second sideband use contact (e.g., the SBU2 or SBU_B pin) and the second terminal node 402-2 that is tied to the ground node 404 corresponds to the first sideband use contact (e.g., the SBU1 or SBU_A pin). Thus, in such implementations, one terminal node of the first terminal node 402-1 (which is coupled to the SBU1 pin) or the second terminal node 402-2 (which is coupled to the SBU2 pin) is coupled to the antenna 116, while another terminal node of the first terminal node 402-1 or the second terminal node 402-2 is grounded.

This grounding of one terminal node may facilitate a determination by the electronic device 112 (e.g., of FIGS. 1-1, 1-2, and 7) of which of the two sideband use pins (SBU1 or SBU2) is coupled to the antenna 116. For example, the electronic device 112 may be configured to determine a presence of an antenna coupled to the device connector 104. In some implementations, the electronic device 112 is configured to detect such an antenna based on signals received over the antenna, e.g., by analyzing one or more pins to determine if signals having certain characteristics are present on those pins, or by applying a signal to those pins and analyzing the response. In other implementations, the electronic device 112 may sense that one or more pins are grounded and may conclude based on the ground sensing that another, non-grounded pin is coupled to an antenna. For instance, in one implementation, the electronic device 112 is configured to determine that one of the first terminal node 402-1 (e.g., the SBU1 pin) or the second terminal node 402-2 (e.g., the SBU2 pin) is coupled to an antenna if the electronic device 112 detects that one (but not both) of the sideband use pins is grounded. This is described further with reference to FIG. 7.

Continuing with the description of FIG. 4, the third terminal node 402-3 that is tied to an audio signal wire 110-1 can correspond to, or be coupled to, a “positive differential” contact or positive differential (DP) pin (e.g., a DP or SDPp1 pin). The fourth terminal node 402-4 that is tied to the other audio signal wire 110-2 can correspond to, or be coupled to, a “negative differential” contact or negative differential (DN) pin (e.g., a DN or SDPn1 pin). Although the audio signal wires 110-1 and 110-2 that are coupled to these contacts or pins are respectively labeled as a positive audio signal wire and a negative audio signal wire in FIGS. 3 and 4, those of skill in the art will understand that this description is used as an example according to certain audio-related implementations that are described herein. However, these wires may alternatively be configured generally as Data+ and Data− wires or connections pursuant to one or more USB standards (such as the USB Type-C standard, for example when the cabling apparatus 102 is configured as an adapter for one or more devices). The fifth terminal node 402-5 that is tied to the power wire 110-3 can correspond to, or be coupled to, a “bus power” contact or bus power (VBUS) pin (e.g., a VBUS or PWR_VBUS1 or PWR_VBUS2 pin). And the sixth terminal node 402-6 that is tied to the ground wire 110-4 can correspond to, or be coupled to, a “ground” contact or ground (GND) pin (e.g., a GND or GND_PWRrt1 or GND_PWRrt2 pin). The coupling of wires from the cable 106 to these six example pins for a USB Type-C connection are depicted more explicitly in FIGS. 5 and 6.

However, these are merely example pins for implementing antenna and audio cabling unification with a USB Type-C connection. Aspects of antenna and audio cabling unification can be implemented with other USB connection types as well as with non-USB connection types. Also, although not illustrated in FIG. 4, a cabling connector 114 (e.g., of FIGS. 1-1, 1-2, and 7) of an electronic device 112 can include corresponding terminal nodes that are coupled to I/O or interface pins to interface with the device connector 104 of the cabling apparatus 102.

FIG. 5 illustrates an example cabling apparatus 102-1 in which the audio endpoint 108-1 is implemented as a digital headset 502 and the cable 106 includes an antenna 116. Here, the device connector 104 is implemented as a USB Type-C plug 406. As shown in FIG. 5, the positive (digital) audio signal wire 110-1 is coupled to the DP pin, and the negative (digital) audio signal wire 110-2 is coupled to the DN pin. The power wire 110-3 is coupled to the VBUS pin, and the ground wire 110-4 is coupled to the GND pin. The antenna 116 is coupled to the SBU1 pin, and the SBU2 pin is grounded. Alternatively, the antenna 116 can be coupled to the SBU2 pin, and the SBU1 pin can be shorted by being coupled to ground. Other antenna-coupling options include: coupling the antenna 116 to both the SBU1 pin and the SBU2 pin; or coupling the antenna 116 to either of the SBU1 or the SBU2 pin, and also coupling the two SBU1 and SBU2 pins to each other via a capacitor. One end of the antenna 116 is floating or uncoupled from the audio endpoint 108-1. By disposing the antenna 116 outside of a ground shield (not shown in FIG. 5) that encloses one or more wires (e.g., the multiple wires 110-1 to 110-4), the antenna 116 can operate more quietly from an EM perspective.

In some implementations, the audio endpoint 108-1 is implemented as a digital headset 502 including digital audio circuitry and multiple endpoint nodes 510-1 to 510-4 to couple with the wires of the cable 106. Although four endpoint nodes 510-1, 510-2, 510-3, and 510-4 are explicitly depicted, more or fewer endpoint nodes may alternatively be implemented. As shown on the left, the digital headset 502 includes a ground node 504, a power supply unit 508, and a digital interface 506. As shown on the right, the digital headset 502 also includes an analog interface 516, one or more speakers 518, and at least one microphone 520. The digital interface 506 includes a first endpoint node 510-1 coupled to the positive audio signal wire 110-1 and a second endpoint node 510-2 coupled to the negative audio signal wire 110-2. The power supply unit 508 includes a power endpoint node 510-3 that is coupled to the power wire 110-3. The ground node 504 corresponds to a ground endpoint node 510-4 that is coupled to the ground wire 110-4 to provide an extended ground reference between the digital headset 502 and an electronic device 112.

The digital interface 506 transmits or receives digital differential data over the positive and negative audio signal wires 110-1 and 110-2 via the first and second endpoint nodes 510-1 and 510-2. The digital interface 506 can be realized using, for example, USB interface circuitry, such as logic circuitry that comports with a USB Type-C protocol. The power supply unit 508 receives a supply voltage from the power wire 110-3 via the power endpoint node 510-3. The power supply unit 508 can be implemented with, for example, a voltage converter or a voltage regulator (e.g., a switched-mode power supply (SMPS) or a low-voltage dropout (LDO) regulator) to generate a local supply voltage on a power rail 522. The power rail 522 distributes power at the local supply voltage to the digital interface 506 and the analog interface 516.

The digital interface 506 is communicatively coupled to the analog interface 516 to exchange audio data therebetween. An analog output 514 of the analog interface 516 is coupled to the speaker 518, and an analog input 512 of the analog interface 516 is coupled to the microphone 520. The analog interface 516 includes circuitry to prepare an analog audio signal and provide the prepared analog audio signal to the speaker 518. The analog interface 516 can also include circuitry to receive an analog audio signal from the microphone 520 and process the received analog audio signal for transmission to the digital interface 506. In example operations, audio data is exchanged between the digital interface 506 and the analog interface 516. If the digital interface 506 includes ADC and DAC circuitry, the audio data can be exchanged in an analog format. On the other hand, if the analog interface 516 includes ADC and DAC circuitry, the audio data can be exchanged in a digital format. Regardless, the analog interface 516 exchanges analog audio data with the speaker 518 and the microphone 520. Thus, the digital headset 502 can provide at least one mechanism for providing an aural output responsive to a digital audio signal received via multiple wires, such as the wires 110-1 and 110-2.

FIG. 6 illustrates an example cabling apparatus 102-2 in which the audio endpoint 108-2 is implemented as an analog audio adapter socket 602 and the cable 106 includes an antenna 116. As depicted, the cabling apparatus 102-2 includes analog audio codec circuitry 608, which includes at least a digital-to-analog converter (DAC) 610 or an analog-to-digital converter (ADC) 612. Here, the device connector 104 is implemented as a USB Type-C plug 406. As shown in FIG. 6, the positive (digital) audio signal wire 110-1 is coupled to the DP pin, and the negative (digital) audio signal wire 110-2 is coupled to the DN pin. The power wire 110-3 is coupled to the VBUS pin, and the ground wire 110-4 is coupled to the GND pin. The antenna 116 is coupled to the SBU1 pin. Alternatively, the antenna 116 can be coupled to the SBU2 pin. Further, the antenna 116 can instead be coupled to both the SBU1 and the SBU2 pins, or the antenna 116 can be coupled to either the SBU1 pin or the SBU2 pin with the two pins also coupled together via a capacitor (not shown). As illustrated, one end of the antenna 116 is floating or uncoupled from the audio endpoint 108-2 and from the analog audio codec circuitry 608.

In some implementations, the audio endpoint 108-2 is implemented as an adapter socket 602. The illustrated analog audio adapter socket 602 includes a receptacle to accept an analog audio plug 604, such as for a 3.5 millimeter (mm) audio jack. The receptacle of the adapter socket 602 includes multiple contacts labeled as “R,” “L,” “MIC,” and “GND.” Each respective contact “R,” “L,” “MIC,” and “GND” corresponds to a respective endpoint node 510-5, 510-6, 510-7, and 510-8 of multiple endpoint nodes 510-5 to 510-8. Although four endpoint nodes 510-5, 510-6, 510-7, and 510-8 are explicitly depicted, more or fewer endpoint nodes may alternatively be implemented at the adapter socket 602. Additionally, the contacts of the adapter socket 602, which are coupled to the multiple endpoint nodes 510-5 to 510-8, may be configured in a different linear order. For example, the depicted order of L-R-GND-MIC corresponds to a U.S. configuration. In Europe, however, the linear order of the contacts is L-R-MIC-GND (not shown). As depicted, the analog audio plug 604 includes corresponding contacts in a U.S. configuration to mate with the receptacle: a left audio contact 606-2 (“L”), a right audio contact 606-1 (“R”), a ground contact 606-4 (“GND”), and a microphone contact 606-3 (“MIC”). In Europe, the linear positions of the ground and microphone contacts are swapped.

In example implementations, the cabling apparatus 102-2 couples the pins of the USB Type-C plug 406 to the multiple endpoint nodes 510-5 to 510-8 using the analog audio codec circuitry 608. For visual clarity, the analog audio codec circuitry 608 is depicted along the cable 106. However, the analog audio codec circuitry 608 may actually be disposed within a housing or a portion of the USB Type-C plug 406 or within a housing or a portion of the adapter socket 602, or be secured to one of the two. These two example physical locations are indicated with dashed lines for the analog audio codec circuitry at 608-1 and at 608-2. Thus, all or a significant portion of the cable 106 may be on one side or the other of the analog audio codec circuitry 608.

As shown on the left, the analog audio codec circuitry 608 is coupled to the positive audio signal wire 110-1, the negative audio signal wire 110-2, the power wire 110-3, and the ground wire 110-4. The analog audio codec circuitry 608 is provided power via the power wire 110-3 and the ground wire 110-4. As shown on the right, the analog audio codec circuitry 608 is coupled individually to each endpoint node 510 of the multiple endpoint nodes 510-5 to 510-8. To facilitate the adaptation between digital and analog signaling, the analog audio codec circuitry 608 includes at least the DAC 610 to provide analog audio data to one or more speakers. In example operation, the DAC 610 receives digital differential signaling for audio data 304 (of FIG. 3) on the positive audio signal wire 110-1 and the negative audio signal wire 110-2. The DAC converts the digital audio data to analog audio data. The DAC 610 then provides the analog audio data to the adapter socket 602 via the “R” endpoint node 510-5 and the “L” endpoint node 510-6. If the analog audio plug 604 and the analog audio codec circuitry 608 both support microphone functionality, the analog audio codec circuitry 608 engages the ADC 612. Specifically, the ADC 612 converts analog microphone audio data received via the “MIC” endpoint node 510-7 to digital audio data and forwards the digital audio data to the DP and DN pins of the USB Type-C plug 406 via the positive audio signal wire 110-1 and the negative audio signal wire 110-2, respectively.

Meanwhile, the antenna 116 is capable of radiating EM signaling and propagating radio signals to the SBU1 pin. In any described implementation, the antenna 116 can be realized using a discrete chip antenna (not explicitly shown) that is coupled to an SBU pin instead of a wireline antenna. With certain cabling apparatus 102-2 implementations, employing a discrete chip antenna enables a cable 106 of an adapter apparatus to be shorter and/or non-flexible. With these approaches that entail use of the analog audio codec circuitry 608, an electronic device 112 can therefore obtain radio signals radiated by the antenna 116 via the SBU1 pin while still providing analog signaling to or receiving analog signaling from an analog audio endpoint 108-2. In alternative implementations, the audio endpoint 108-2 comprises an analog headset with at least one speaker and optionally a microphone (not shown in FIG. 6) instead of an adapter socket 602.

To accommodate a European-style analog audio plug 604, the GND and MIC contacts can be swapped in the adapter socket 602 or appropriately handled by the analog audio codec circuitry 608 with a fixed circuitry approach. Alternatively, the analog audio codec circuitry 608 can accommodate both the US and the European configurations by including switching circuitry that routes the endpoint nodes 510-7 and 510-8 depending on the inserted analog audio plug 604. Further, the analog audio codec circuitry 608 can include circuitry to sense ground or detect an impedance of a microphone to determine which contact is coupled to which functionality. The analog audio codec circuitry 608 then controls the switching circuitry responsive to the determination.

FIG. 7 illustrates an example electronic device 112 including a cabling connector 114, switching circuitry 174, and a connector interface controller 172. Here, the cabling connector 114 is implemented as a USB Type-C receptacle 702. The switching circuitry 174 is coupled between the USB Type-C receptacle 702 and the connector interface controller 172. The switching circuitry 174 enables the electronic device 112 to operate with an analog or a digital cabling apparatus that is connected to the USB Type-C receptacle 702 under the control of the connector interface controller 172.

In some implementations, the connector interface controller 172 includes a digital interface 704, an FM radio 706, and analog audio codec circuitry 708. In other implementations, the FM radio 706 or the analog audio codec circuitry 708 may be separate from the connector interface controller 172. Each of these components includes at least one input/output node. For example, the analog audio codec circuitry 708 includes a left analog audio node (“HPL”), a right analog audio node (“HPR”), a ground-sense node (“GND_SENSE”), and a microphone node (“MIC”). The FM radio 706 (e.g., an FM transmitter, an FM receiver, or both) includes an antenna node (“ANT”), or antenna node 716-3. The digital interface 704 includes a digital negative node (“DN”), or negative interface node 716-2, and a digital positive node (“DP”), or positive interface node 716-1, such as for digital differential signaling. The digital interface 704 can be realized using appropriate logic, including USB interface circuitry, such as that which comports with a USB Type-C protocol. The connector interface controller 172 controls the switching circuitry 174 using at least one switch control signal 712. The analog audio codec circuitry 708 can be employed if an analog headset with a digital device connector 104 (e.g., a USB Type-C plug 406) may be connected to the cabling connector 114 (e.g., a USB Type-C receptacle 702). However, in some implementations, the analog audio codec circuitry 708 is omitted to save space or reduce costs. For example, if analog audio signaling is not to be directly or automatically supported by an electronic device 112 or at the associated connector, the analog audio codec circuitry 708 can be omitted. In some such implementations, certain one or ones of the switches 710-1 to 710-4, or the entirety of the switching circuitry 174, may be omitted. For example, in one implementation, a switch which selectively couples one or both of the SBU pins of the USB Type-C receptacle 702 to either the FM radio 706 or to one or more other circuits is included and the other switches are omitted.

In the implementation illustrated in FIG. 7, the switch control signal 712 controls a position or switch state of one or more switches 710 of the switching circuitry 174. Thus, the switching circuitry 174 includes multiple switches 710-1 to 710-4. Although four switches 710 are explicitly shown, more or fewer switches may alternatively be implemented by the switching circuitry 174. Each switch 710 includes a single node side and a multi-node side. Each switch 710 can be controlled so as to cause a given switch 710 to enter a switch state that couples the node on the single node side to a selected node on the multi-node side. The switches 710-1 and 710-2 pertain to audio data in a digital form or in an analog form. The switches 710-3 and 710-4 pertain to a microphone signal, a ground reference, or an antenna signal.

The switch 710-1 includes a negative digital data node (“DN_IN”), an analog left node (“L_IN”), and a negative/left combination node (“DN_L”). The switch 710-2 includes a positive digital data node (“DP_IN”), an analog right node (“R_IN”), and a positive/right combination node (“DP_R”). The switch 710-3 includes a second sideband use node (“SBU2”), a first sideband use node (“SBU1”), and a sense-out node (“SENSE_OUT”). The switch 710-4 includes a second sideband use node (“SBU2”), a first sideband use node (“SBU1”), and a microphone-out node (“MIC_OUT”).

The various nodes are coupled to another node or to a pin of the USB Type-C receptacle 702 as follows. For the switch 710-1: The negative digital data node (“DN_IN”) is coupled to the digital negative node (“DN”). The analog left node (“L_IN”) is coupled to the left analog audio node (“HPL”). The negative/left combination node (“DN_L”) is coupled to the DN pin of the USB Type-C receptacle 702. For the switch 710-2: The positive digital data node (“DP_IN”) is coupled to the digital positive node (“DP”). The analog right node (“R_IN”) is coupled to the antenna node (“ANT”) and to the right analog audio node (“HPR”). The positive/right combination node (“DP_R”) is coupled to the DP pin of the USB Type-C receptacle 702.

For the switches 710-3 and 710-4: The second sideband use nodes (“SBU2”) of both switches are coupled to the SBU2 pin of the USB Type-C receptacle 702. The first sideband use nodes (“SBU 1”) of both switches are coupled to the SBU1 pin of the USB Type-C receptacle 702. The microphone-out node (“MIC_OUT”) of the switch 710-4 is coupled to the microphone node (“MIC”). The sense-out node (“SENSE_OUT”) of the switch 710-3 is coupled to the ground-sense node (“GND_SENSE”) and to the antenna node (“ANT”). Although not depicted, the nodes or pins may be coupled together via one or more other components. For example, the analog right node (“R_IN”) and the sense-out node (“SENSE_OUT”) may each be coupled to the antenna node (“ANT”) via a respective capacitor. Also, the different nodes coupled to the analog audio codec circuitry 708 can be coupled thereto via an inductive element.

The nodes of the switching circuitry 174 that are coupled to the USB Type-C receptacle 702 comprise one or more terminal nodes 714. Examples of terminal nodes 714 include the negative/left combination node (“DN_L”), the positive/right combination node (“DP_R”), the two first sideband use nodes (“SBU1”), and the two second sideband use nodes (“SBU2”). For clarity, four terminal nodes are explicitly identified. With regard to the switch 710-3, the first sideband use node (“SBU1”) comprises a first terminal node 714-1, and the second sideband use node (“SBU2”) comprises a second terminal node 714-2. The switch 710-2 includes the positive/right combination node (“DP_R”) that comprises a third terminal node 714-3, and the switch 710-1 includes the negative/left combination node (“DN_L”) that comprises a fourth terminal node 714-4. If one or more of the multiple switches 710-1 to 710-4 are omitted, the corresponding nodes of the connector interface controller 172 can comprise terminal nodes. For example, if the switches 710-1 and 710-2 are omitted, the positive interface node 716-1 and the negative interface node 716-2 can comprise terminal nodes. Similarly, the antenna node 716-3 can comprise a terminal node.

In example implementations, the connector interface controller 172 provides one or more switch control signals 712 to control the positions or switch states of one or more of the switches 710-1 to 710-4. If the cabling connector 114 is coupled to a digital cabling apparatus 102, the connector interface controller 172 uses the switch control signal 712 to place the switches 710-1 and 710-2 in a digital mode. For example, the switch 710-1 is positioned in a switch state to couple the negative/left combination node (“DN_L”) to the negative digital data node (“DN_IN”). Also, the switch 710-2 is positioned in a switch state to couple the positive/right combination node (“DP_R”) to the positive digital data node (“DP_IN”). On the other hand, if the cabling connector 114 is coupled to an analog cabling apparatus 102, the connector interface controller 172 uses the switch control signal 712 to place the switches 710-1 and 710-2 in an analog mode. For example, the switch 710-1 is positioned in a switch state to couple the negative/left combination node (“DN_L”) to the analog left node (“L_IN”). Also, the switch 710-2 is positioned in a switch state to couple the positive/right combination node (“DP_R”) to the analog right node (“R_IN”). Thus, the switches 710-1 and 710-2 are both in the digital mode or both in the analog mode.

In contrast, the switches 710-3 and 710-4 are in opposite positions with respect to the first and second sideband use nodes (SBU1 and SBU2). The connector interface controller 172 determines which of the SBU1 or SBU2 nodes is coupled to the antenna 116 of a connected cabling apparatus 102 (not shown in FIG. 7). The connector interface controller 172 can make this determination using any of multiple techniques that are applied, for example, to the first and second terminal nodes 714-1 and 714-2. First, the analog audio codec circuitry 708 can sense which terminal node—SBU1 or SBU2—is coupled to ground using ground-sense circuitry coupled to the ground-sense node (“GND_SENSE”). The other terminal node—SBU2 or SBU1, respectively—is therefore coupled to the antenna 116. Second, the FM radio 706 can search for and detect an FM station by demodulating a received radio wireless signal. The terminal node on which the FM signal is detected is coupled to the antenna 116. In some situations, the antenna 116 can be coupled to both the SBU1 pin and the SBU2 pin instead of one pin. In other situations, two separate antennas (not illustrated) can be coupled to the SBU1pin and the SBU2 pin. Such antennas may be shielded from each other and/or may be placed on opposite sides of a set of other wires, for example one or more of the wires 110-1 to 110-3. The terminal node—SBU1 or SBU2—with the only FM reception or with the stronger FM reception can be selected as being coupled to the antenna 116. Third, the connector interface controller 172 can use a detected impedance to select between the SBU1 and SBU2 nodes. Some USB circuitry, for instance, can detect impedances.

If the connector interface controller 172 determines that the antenna 116 is coupled to the SBU1 pin of the USB Type-C receptacle 702, one switch control signal 712 causes the switch 710-3 to enter a switch state that couples the sense-out node (“SENSE_OUT”), and thus the antenna node (“ANT”), to the first sideband use node (“SBU1”). Another switch control signal 712 (e.g., a separate signal or an inverted version of the one switch control signal) therefore causes the switch 710-4 to enter a switch state that couples the microphone-out node (“MIC_OUT”) to the second sideband use node (“SBU2”). On the other hand, the connector interface controller 172 may determine that the antenna 116 is coupled to the SBU2 pin of the USB Type-C receptacle 702. If so, one switch control signal 712 causes the switch 710-3 to enter a switch state that couples the sense-out node (“SENSE_OUT”), and thus the antenna node (“ANT”), to the second sideband use node (“SBU2”). Another switch control signal 712 therefore causes the switch 710-4 to enter a switch state that couples the microphone-out node (“MIC_OUT”) to the first sideband use node (“SBU2”). Thus, regardless of which SBU pin is coupled to the antenna, the connector interface controller 172 can cause the switching circuitry 174 to route received radio wireless signals to the FM radio 706.

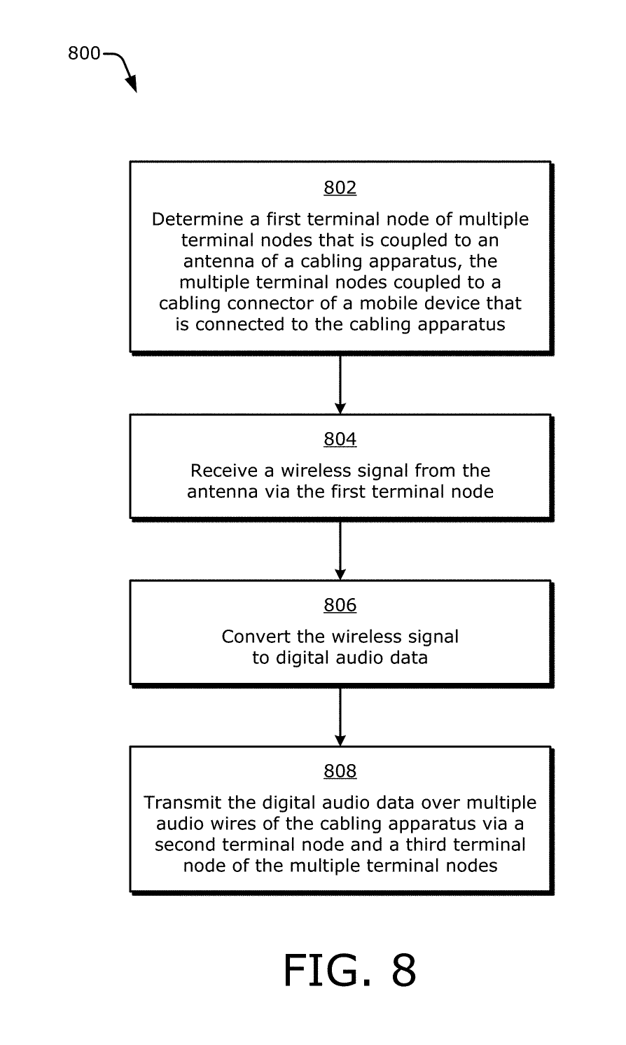

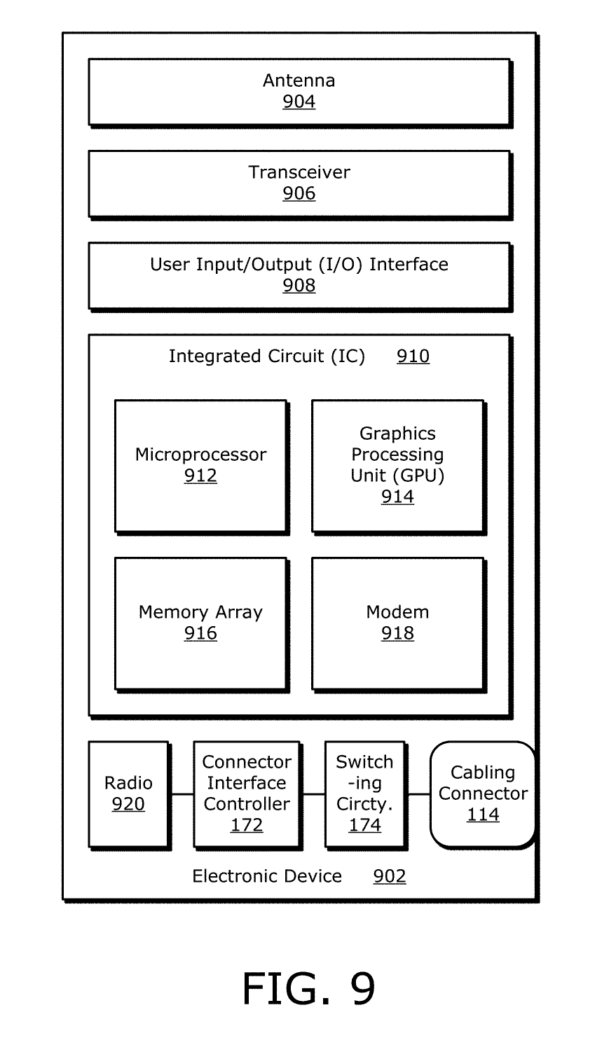

FIG. 8 is a flow diagram illustrating an example process 800 for antenna and audio unification that can be performed by an electronic device that is coupled to a cabling apparatus as described herein. The process 800 is described in the form of a set of blocks 802-810 that specify operations that can be performed. However, operations are not necessarily limited to the order shown in FIG. 8 or described herein, for the operations may be implemented in alternative orders or in fully or partially overlapping manners. Operations represented by the illustrated blocks of the process 800 may be performed by an electronic device (e.g., an electronic device 112 of FIG. 1-1, 1-2, or 7 or an electronic device 902 of FIG. 9) that is coupled to a cabling apparatus 102 as described herein. More specifically, the operations of the process 800 may be performed by a connector interface controller 172 or a switching circuitry 174 as shown in FIG. 7.

At block 802, a first terminal node of multiple terminal nodes is determined to be coupled to an antenna of a cabling apparatus, with the multiple terminal nodes coupled to a cabling connector of a mobile device that is connected to the cabling apparatus. For example, a connector interface controller 172 of an electronic device 112 (e.g., a mobile device such as a smartphone, tablet, or smartwatch) can determine a first terminal node of multiple terminal nodes 714 that is coupled to an antenna 116 of a cabling apparatus 102, with the multiple terminal nodes coupled to a cabling connector 114 that is connected to the cabling apparatus 102. To do so, the connector interface controller 172 can analyze at least a first terminal node 714 (e.g., a terminal node 714-1 and a terminal node 714-2) of multiple terminal nodes of switching circuitry 174 that is coupled to the cabling connector 114. The analysis may include, for example, sensing a ground potential or determining a radio signal exists or detecting an impedance level. During the analysis, the cabling connector 114 is coupled to a device connector 104 of the cabling apparatus 102. Based on the analysis, a first terminal node 714 of the multiple terminal nodes is identified as being coupled to the antenna 116 of the cabling apparatus 102. For instance, if a fourth terminal node 714 (e.g., the terminal node 714-2) of multiple terminal nodes is determined to be coupled to ground, or if the first terminal node (e.g., the terminal node 714-1) is determined to provide a radio signal based on the analysis, the connector interface controller 172 identifies the first terminal node (e.g., the terminal node 714-1) as being coupled to the antenna 116 of a cable 106 of the cabling apparatus 102.

At block 804, a wireless signal is received from the antenna via the first terminal node. For example, a radio (e.g., the FM radio 706) can receive a radio wireless signal 118-1 from the antenna 116 via the first terminal node (e.g., the terminal node 714-1) that is coupled to a first pin of the cabling connector 114. The cabling connector 114 can be implemented in accordance with a USB Type-C protocol as a USB Type-C receptacle 702 such that the first pin corresponds to a first sideband use (SBU1) pin. To obtain the wireless signal, the connector interface controller 172 can provide a switch control signal 712 to a switch 710-3 of the switching circuitry 174 as part of the determining. The switch control signal 712 causes the switch 710-3 to enter a switch state that couples the first sideband use node (“SBU1”) thereof to a sense-out node (“SENSE_OUT”) thereof. The sense-out node (“SENSE_OUT”) is coupled to an antenna node (“ANT”) of the radio.

At block 806, the wireless signal is converted to digital audio data. For example, the radio (e.g., the FM radio 706) or the digital interface 704 (e.g., USB circuitry) can convert a demodulated radio wireless signal 118-1 to a digital version of audio data 304. The radio can provide the audio data 304 to the digital interface 704 of the connector interface controller 172. The digital interface 704 can process the audio data 304, such as to prepare the digital audio data 304 for digital transmission over a differential propagation medium as a differential digital signal.

At block 808, the digital audio data is transmitted over multiple audio wires of the cabling apparatus via a second terminal node and a third terminal node of the multiple terminal nodes. For example, the connector interface controller 172 can use the cabling connector 114 to transmit digital audio data 304 over multiple audio wires 302 of the cabling apparatus 102 via a second terminal node and a third terminal node (e.g., the terminal nodes 714-3 and 714-4) of the multiple terminal nodes 714. For instance, the differential digital signal may be propagated over a positive audio signal wire 110-1 and a negative audio signal wire 110-2 of the multiple audio wires 302 via the second and third terminal nodes. To do so, the connector interface controller 172 provides at least one switch control signal 712 to cause the switches 710-1 and 710-2 to be in a digital mode. For example, the switch 710-1 can enter a switch state that couples the negative/left combination node (“DN_L”) to the negative digital data node (“DN_IN”), and the switch 710-2 can enter a switch state that couples the positive/right combination node (“DP_R”) to the positive digital data node (“DP_IN”). The negative digital data node (“DN_IN”) and the positive digital data node (“DP_IN”) are both coupled to the digital interface 704 to receive the audio data 304 that was demodulated by the radio.

FIG. 9 illustrates an example electronic device 902 that includes a cabling connector 114, switching circuitry 174, a connector interface controller 172, and a radio 920. As shown, the electronic device 902 also includes an antenna 904, a transceiver 906, a user input/output (I/O) interface 908, and an integrated circuit 910. Illustrated examples of the integrated circuit 910, or cores thereof, include a microprocessor 912, a graphics processing unit (GPU) 914, a memory array 916, and a modem 918.

In one or more implementations, antenna and audio cabling unification techniques as described herein can be implemented by the electronic device 902, which is an example of the electronic device 112 of FIGS. 1-1 and 1-2. The cabling connector 114 is coupled to the connector interface controller 172 via the switching circuitry 174. The connector interface controller 172 is coupled to the radio 920. In operation, the connector interface controller 172 enables other components, such as the radio 920, to interface with the cabling connector 114 using the switching circuitry 174. In some implementations, the connector interface controller 172 can be realized at least partially as a USB controller. In some aspects, the radio 920 is configured to at least receive and process wireless signals in the FM broadcast radio band and can be implemented in such situations with the FM radio 706 (of FIG. 7). The connector interface controller 172 may be configured to perform or cause the device to implement the functions related to determining whether an antenna is coupled to the cabling connector 114 as described above with reference to FIG. 7 or those related to using an antenna that is part of a cabling apparatus 102 for radio reception.

The electronic device 902 can be a mobile or battery-powered device or a fixed device that is designed to be powered by an electrical grid. Examples of the electronic device 902 include a server computer, a network switch or router, a blade of a data center, a personal computer, a desktop computer, a notebook or laptop computer, a tablet computer, a smart phone, an entertainment appliance, or a wearable computing device such as a smartwatch, intelligent glasses, or an article of clothing. An electronic device 902 can also be a device, or a portion thereof, having embedded electronics. Examples of the electronic device 902 with embedded electronics include a passenger vehicle, industrial equipment, a refrigerator or other home appliance, a drone or other unmanned aerial vehicle (UAV), or a power tool.

For an electronic device with a wireless capability, the electronic device 902 includes an antenna 904 that is coupled to a transceiver 906 to enable reception or transmission of one or more wireless signals, such as those in a cellular or Wi-Fi network band. The antenna 904 is, however, typically too small to facilitate satisfactory FM radio signal reception. The integrated circuit 910 may be coupled to the transceiver 906 to enable the integrated circuit 910 to have access to received wireless signals or to provide wireless signals for transmission via the antenna 904. The electronic device 902 as shown also includes at least one user I/O interface 908. Examples of the user I/O interface 908 include a keyboard, a mouse, a microphone, a touch-sensitive screen, a camera, an accelerometer, a haptic mechanism, a speaker, a display screen, a fingerprint or other biometric sensor, or a projector.

The integrated circuit 910 may comprise, for example, one or more instances of a microprocessor 912, a GPU 914, a memory array 916, a modem 918, and so forth. The microprocessor 912 may function as a central processing unit (CPU) or other general-purpose processor. Some microprocessors include different parts, such as multiple processing cores, that may be individually powered on or off. The GPU 914 may be especially adapted to process visual-related data for display. The memory array 916 stores data for the microprocessor 912 or the GPU 914. Example types of memory for the memory array 916 include random access memory (RAM), such as dynamic RAM (DRAM) or static RAM (SRAM); flash memory; and so forth. The modem 918 demodulates a signal to extract encoded information or modulates a signal to encode information into the signal. If there is no information to decode from an inbound communication or to encode for an outbound communication, the modem 918 may be idled to reduce power consumption. The integrated circuit 910 may include additional or alternative parts than those that are shown, such as an I/O interface, a sensor such as an accelerometer, a transceiver or another part of a receive or transmit chain, a customized or hard-coded processor such as an application-specific integrated circuit (ASIC), at least part of the connector interface controller 172, and so forth.

The integrated circuit 910 may also comprise a system on a chip (SOC). An SOC may integrate a sufficient number of different types of components to enable the SOC to provide computational functionality as a notebook computer, a mobile phone, an IoT device, or another electronic apparatus using one chip, at least primarily. Components of an SOC, or an integrated circuit 910 generally, may be termed cores or circuit blocks. Examples of cores or circuit blocks include, in addition to those that are illustrated in FIG. 9, a voltage or power regulator, a main memory or cache memory block, a memory controller, a general-purpose processor, a cryptographic processor, a video or image processor, a vector processor, a radio, an interface or communications subsystem, a wireless controller, a display controller, an audio codec, digital interface logic, the radio 920, the connector interface controller 172, or the switching circuitry 174. Any of these cores or circuit blocks, such as a processing or GPU core, may further include multiple internal cores or circuit blocks.

In some implementations, the connector interface controller 172 can be realized using a processing unit and processor-executable instructions that are stored on non-transitory processor accessible media. Examples of a processing unit include a general-purpose processor, an application specific integrated circuit (ASIC), a microprocessor, a digital signal processor (DSP), hard-coded discrete logic, or a combination thereof. The processor-accessible media can include memory to retain the processor-executable instructions for software, firmware, hardware modules, and so forth. Memory may be volatile or nonvolatile memory, such as random access memory (RAM), read only memory (ROM), flash memory, static RANI (SRAM), or a combination thereof. Additionally or alternatively, a given controller can be realized using analog circuitry, such as resistors and comparators; digital circuitry, such as transistors and flip-flops; combinations thereof; and so forth. The processor-executable instructions, or other forms of circuitry or controller instantiations, can be implemented in accordance with the techniques and apparatuses described herein.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An electronic device, comprising:
a cabling connector including multiple pins configured to couple the electronic device to a device connector of an external cabling apparatus, the multiple pins including a positive digital pin, a negative digital pin, and a first other pin;
a digital interface including a positive interface node and a negative interface node; the positive interface node coupled to the positive digital pin, and the negative interface node coupled to the negative digital pin; and
a radio including an antenna node coupled to at least the first other pin.

2. The electronic device of claim 1, wherein the radio is configured to demodulate an analog wireless signal obtained via the antenna node, and wherein the digital interface is configured to provide digital audio data via the positive interface node and the negative interface node based on the demodulated analog wireless signal.

3. The electronic device of claim 2, wherein the radio comprises a frequency modulated (FM) radio, and wherein the digital interface is configured to provide digital audio data based on a demodulated analog FM radio wireless signal.

4. The electronic device of claim 1, wherein:
the cabling connector comprises a Universal Serial Bus (USB) Type-C connector; and
the first other pin comprises a sideband use (SBU) pin.

5. The electronic device of claim 4, wherein the positive digital pin comprises a positive differential (DN) pin, and the negative digital pin comprises a negative differential (DN) pin.

6. The electronic device of claim 4, further comprising:
switching circuitry coupled to the cabling connector, the switching circuitry including a first switch,
wherein the antenna node is switchably coupled to a first SBU (SBU1) pin or a second SBU (SBU2) pin via the first switch.

7. The electronic device of claim 6, further comprising:
a connector interface controller configured to determine a pin of the SBU1 pin or the SBU2 pin that is coupled to an antenna of the cabling apparatus, wherein:
the first switch includes:
a multi-node side that is coupled to the SBU1 pin and the SBU2 pin; and
a single node side that is coupled to the radio; and
the connector interface controller is configured to cause the first switch to enter a switch state that couples the determined pin of the SBU1 pin or the SBU2 pin to the radio.

8. The electronic device of claim 6, further comprising:
analog audio codec circuitry coupled to the switching circuitry,
wherein the switching circuitry includes:
a second switch having a single node side that is coupled to the DN pin and having a multi-node side that is coupled to the analog audio codec circuitry and the digital interface; and
a third switch having a single node side that is coupled to the DP pin and having a multi-node side that is coupled to the analog audio codec circuitry and the digital interface.

9. A method, comprising:
determining a first terminal node of multiple terminal nodes that is coupled to an antenna of a cabling apparatus, the multiple terminal nodes coupled to a cabling connector of a mobile device that is connected to the cabling apparatus;
receiving a wireless signal from the antenna via the first terminal node;
converting the wireless signal to digital audio data; and
transmitting the digital audio data over multiple audio wires of the cabling apparatus via a second terminal node and a third terminal node of the multiple terminal nodes.

10. The method of claim 9, wherein the determining comprises analyzing the first terminal node and a fourth terminal node of the multiple terminal nodes, including at least one of:
sensing if the first terminal node or the fourth terminal node is coupled to ground;
detecting an impedance at the first terminal node or the fourth terminal node; or
demodulating a radio wireless signal received via the first terminal node or the fourth terminal node.

11. The method of claim 9, wherein the transmitting comprises:
generating a differential digital signal based on the digital audio data; and
propagating the differential digital signal over a positive audio signal wire and a negative audio signal wire of the multiple audio wires respectively via the second terminal node and the third terminal node of the multiple terminal nodes.

12. The method of claim 9, wherein the determining comprises causing a switch to toggle between the first terminal node and a fourth terminal node of the multiple terminal nodes.

13. The method of claim 12, wherein:
one terminal node of the first terminal node or the fourth terminal node is coupled to a first sideband use (SBU1) pin of the cabling connector, and another terminal node of the first terminal node or the fourth terminal node is coupled to a second sideband use (SBU2) pin of the cabling connector; and
the determining comprises causing the switch to select to couple the first terminal node to a radio.

14. The method of claim 9, wherein:
the first terminal node is coupled to at least one of a first sideband use (SBU1) pin or a second sideband use (SBU2) pin of the cabling connector;
the wireless signal comprises a frequency-modulated (FM) radio wireless signal;
the second terminal node is coupled to a negative differential (DN) pin of the cabling connector, and the third terminal node is coupled to a positive differential (DP) pin of the cabling connector;
the determining comprises causing a switch to couple the first terminal node to a radio;
the receiving comprises receiving the FM radio wireless signal from the antenna via at least one of the SBU1 pin or the SBU2 pin of the cabling connector;
the converting comprises converting the FM radio wireless signal to the digital audio data; and
the transmitting comprises transmitting the digital audio data over the multiple audio wires of the cabling apparatus via the DN pin and the DP pin of the cabling connector.

15. An apparatus comprising:
a device connector including multiple terminal nodes;
an audio endpoint including multiple endpoint nodes; and
a cable coupled between the device connector and the audio endpoint, the cable including:
multiple wires coupled between at least two respective nodes of the multiple terminal nodes of the device connector and at least two respective nodes of the multiple endpoint nodes of the audio endpoint; and
an antenna coupled to at least one of the multiple terminal nodes of the device connector and uncoupled from the audio endpoint.

16. The apparatus of claim 15, wherein:
the cable further includes a shielding component; and
the shielding component is interposed between the antenna and at least a portion of the multiple wires.

17. The apparatus of claim 16, wherein:
the shielding component comprises a cylindrical shielding layer that encases the at least a portion of the multiple wires; and
the antenna is disposed external to the shielding component.

18. The apparatus of claim 16, wherein the shielding component is configured to shield the antenna from radio frequency (RF) interference radiated from the at least a portion of the multiple wires as digital audio data propagates along the at least a portion of the multiple wires.

19. The apparatus of claim 15, wherein the multiple wires coupled between the at least two respective nodes of the multiple terminal nodes of the device connector and the at least two respective nodes of the multiple endpoint nodes of the audio endpoint include:
a positive audio signal wire;
a negative audio signal wire;
a power wire; and
a ground wire.

20. The apparatus of claim 19, wherein:
the positive audio signal wire and the negative audio signal wire are configured to propagate digital audio data;
the power wire is configured to provide to the audio endpoint power from an electronic device via the device connector;
the ground wire is configured to provide a reference for the power provided from the electronic device via the device connector; and
the audio endpoint comprises a digital headset.

21. The apparatus of claim 20, wherein the digital headset includes:
a digital interface having the at least two of the multiple endpoint nodes;
an analog interface communicatively coupled to the digital interface;
at least one speaker coupled to an analog output of the analog interface; and
at least one microphone coupled to an analog input of the analog interface.

22. The apparatus of claim 20, wherein the digital headset includes:
a power supply unit having a power endpoint node of the multiple endpoint nodes of the audio endpoint, the power endpoint node coupled to the power wire; and
a ground endpoint node of the multiple endpoint nodes of the audio endpoint, the ground endpoint node coupled to the ground wire.

23. The apparatus of claim 15, wherein the device connector is configured to comport with a Universal Serial Bus (USB) specification for a Type-C connector.

24. The apparatus of claim 23, wherein:
the device connector includes a sideband use (SBU) pin; and
the SBU pin is coupled to the at least one terminal node to which the antenna is coupled.

25. The apparatus of claim 24, wherein:
the device connector includes:
a positive differential (DP) pin;
a negative differential (DN) pin;
a bus power (VBUS) pin; and
a ground (GND) pin;
the antenna is coupled to the SBU pin via the at least one terminal node of the device connector; and
the multiple wires include:
a positive audio signal wire coupled to the DP pin via the at least two of the multiple terminal nodes of the device connector;
a negative audio signal wire coupled to the DN pin via the at least two of the multiple terminal nodes of the device connector;
a power wire coupled to the VBUS pin via a terminal node of the multiple terminal nodes of the device connector; and
a ground wire coupled to the GND pin via another terminal node of the multiple terminal nodes of the device connector.

26. The apparatus of claim 15, wherein:
the apparatus comprises analog audio codec circuitry coupled between the multiple terminal nodes and the multiple endpoint nodes;
the multiple wires are coupled between the at least two of the multiple terminal nodes of the device connector and the at least two of the multiple endpoint nodes of the audio endpoint via the analog audio codec circuitry; and
the antenna is uncoupled from the analog audio codec circuitry.

27. An electronic device, comprising:
means for coupling the electronic device to an external cabling apparatus;
means for processing analog signals wirelessly received via an antenna, the means for processing analog signals being coupled to the means for coupling; and
means for providing digital audio data based on the analog signals wirelessly received via the antenna, the means for providing digital audio data being coupled to the means for processing analog signals and the means for coupling.

28. The electronic device of claim 27, wherein:
the means for coupling comprises a receptacle comporting with a Universal Serial Bus (USB) Type-C configuration; and
the means for processing analog signals is coupled to a first sideband use (SBU1) pin or a second sideband use (SBU2) pin of the receptacle.

29. The electronic device of claim 27, further comprising:
means for switching coupled between a first pin and a second pin of the means for coupling, and the means for processing analog signals; and
means for controlling the means for switching to selectively couple the first pin or the second pin to the means for processing analog signals.

30. The electronic device of claim 27, wherein:
the means for coupling comprises multiple pins including a positive digital pin and a negative digital pin; and
the means for providing digital audio data is coupled to the positive digital pin and the negative digital pin.
